(19) United States
(12) Patent Application Publication
(10) Pub. No.: US 2011/0211765 A1
(43) Pub. Date: Sep. 1, 2011

(54) IMAGE PROCESSING APPARATUS, IMAGE PROCESSNIG METHOD, AND PROGRAM

(75) Inventors: Takefumi Nagumo, Kanagawa (JP); Takeshi Miyai, Kanagawa (JP); Michel Xavier, Chiba (JP)

(73) Assignee: Sony Corporation, Tokyo (JP)

(21) Appl. No.: 13/033,358

(22) Filed: Feb. 23, 2011

(30) Foreign Application Priority Data
Mar. 1, 2010 (JP) 2010-043699

(51) Int. Cl. G06K 9/40

(52) U.S. Cl. 382/254

(57) ABSTRACT

Provided is an image processing apparatus including a super resolving processor including: a high frequency estimator which generates difference image information between a low resolution image input as a processing object image of a super resolving process and a mid-processing image of the super resolving process or a processed image, that is, an initial image; and a calculator which performs a process of updating the processed image through a process of calculation between the difference image information output from the high frequency estimator and the processed image, wherein the high frequency estimator performs a learning type data process using learned data in the difference image information generating process.

### BACKGROUND OF THE INVENTION

1. Field of the Invention

The present invention relates to an image processing apparatus, an image processing method, and a program, and more particularly, to an image processing apparatus, an image processing method, and a program performing a super resolving process for increasing a resolution of an image.

2. Description of the Related Art

As a method of generating a high resolution image from a low resolution image, a super resolving process is well known. The super resolving process is a process of generating a high resolution image from a low resolution image.

For example, as a super resolving process method, there are the following methods.

(a) Reconstruction Type Super Resolving Method

(b) Learning Type Super Resolving Method

The reconstruction type super resolving method (a) is a method of deriving parameters representing photographing conditions such as “blur caused by lens and atmosphere scattering”, “motion of a subject and the entire camera”, and “sampling by the imaging device” based on the low resolution image which is the photographed image and estimating an ideal high resolution image by using the parameters.

In addition, in the related art, the reconstruction type super resolving method is disclosed in, for example, Japanese Unexamined Patent Application Publication No. 2008-140012.

The overview of the processes of the reconstruction type super resolving method is as follows.

(1) An image photographing model is expressed by the equations by taking into consideration the blur, the motion, the sampling, and the like.

(2) A cost calculation equation is obtained from the image photographing model expressed by the equation model. At this time, in some cases, regularized terms of pre-establishment or the like may be added by using Bayes' theorem.

(3) An image for minimizing the cost is obtained.

The reconstruction type super resolving method is a method of obtaining a high resolution image by using the above processes. In addition, specified processes are described in detail in the front section of the specification of the invention.

Although the high resolution image obtained according to the reconstruction type super resolving method depends on the input image, the super resolving effect (resolution recovering effect) is high.

On the other hand, the learning type super resolving method (b) is a method of performing a super resolving process using learned data which are generated in advance. The learned data are constructed with, for example, transform information for a high resolution image from a low resolution image, or the like. A learned data generating process is performed as a process of comparing an assumed input image (low resolution image) generated through, for example, a simulation or the like with an ideal image (high resolution image) and generating transform information for generating a high resolution image from the low resolution image.

The learned data are generated, and the low resolution image as a new input image is converted into the high resolution image by using the learned data.

In addition, in the related art, the learning type super resolving method is disclosed in, for example, Japanese Patent No. 3321915.

According to the learning type super resolving method, if the learned data are generated, the high resolution image can be obtained as stabilized output results with respect to various input images.

However, with respect to the reconstruction type super resolving method (a), although high performance can be generally expected, there are restrictions such as “A plurality of the low resolution images is necessarily input”, and “There is a limitation in the frequency band of the input image, or the like”. In the case where the input image (low resolution image) which does not satisfy these restrictive conditions may not be obtained, there is a problem in that the reconstruction performance may not be sufficiently obtained and the sufficient high resolution image may not be generated.

On the other hand, with respect to the learning type super resolving method (b), although the restriction caused by the number of the input images and the properties of the input image is low and stabilized, there is a problem in that the peak performance of the finally-obtained high resolution image does not reach the reconstruction type super resolving.

### SUMMARY OF THE INVENTION

It is desirable to provide an image processing apparatus, an image processing method, and a program capable of implementing a super resolving method using advantages of a reconstruction type super resolving method and a learning type super resolving method.

According to an embodiment of the invention, there is provided an image processing apparatus including a super resolving processor including: a high frequency estimator which generates difference image information between a low resolution image input as a processing object image of a super resolving process and a mid-processing image of the super resolving process or a processed image, that is, an initial image; and a calculator which performs a process of updating the processed image through a process of calculation between the difference image information output from the high frequency estimator and the processed image, wherein the high frequency estimator performs a learning type data process using learned data in the difference image information generating process.

In addition, in the image processing apparatus according to the above embodiment of the invention the high frequency estimator performs the learning type super resolving process in an upsampling process of a downsampling processed image which is converted to have the same resolution as that of the low resolution image through a downsampling process of the processed image constructed with the high resolution images.

In addition, in the image processing apparatus according to the above embodiment of the invention, the high frequency estimator may perform the learning type super resolving process in an upsampling process of the low resolution image input as a processing object image of the super resolving process.

In addition, in the image processing apparatus according to the above embodiment of the invention, the high frequency estimator may perform the upsampling process as a learning type super resolving process using the learned data including data corresponding to feature amount information of a localized image area of the low resolution image and the high resolution image generated based on the low resolution image and image transform information for converting the low resolution image into the high resolution image.

In addition, in the image processing apparatus according to the above embodiment of the invention, the high frequency estimator may perform the learning type super resolving process in an upsampling process on the difference image between a downsampling processed image, which is converted to have the same resolution as that of the low resolution image through a downsampling process of the processed image constructed with the high resolution images, and the low resolution image input as a processing object image of the super resolving process.

In addition, in the image processing apparatus according to the above embodiment of the invention, the high frequency estimator may perform the upsampling process as a learning type super resolving process using the learned data including data corresponding to feature amount information of a localized image area of the difference image between the low resolution image and the high resolution image generated based on the low resolution image and image transform information for converting the difference image into the high resolution difference image.

In addition, in the image processing apparatus according to the above embodiment of the invention, the super resolving processor may have a configuration of performing a resolution converting process by using a reconstruction type super resolving method and performs the learning type super resolving process using the learned data in the upsampling process of the resolution converting process.

In addition, in the image processing apparatus according to the above embodiment of the invention, the super resolving processor may have a configuration of performing the resolution converting process by taking into consideration a blur and a motion of an image and a resolution of an imaging device according to the reconstruction type super resolving method and performs the learning type super resolving process using the learned data in the upsampling process of the resolution converting process.

In addition, in the image processing apparatus according to the above embodiment of the invention, the image processing apparatus may further include a convergence determination portion which performs convergence determination on a calculation result of the calculator, wherein the convergence determination portion performs the convergence determination process according to a predefined convergence determination algorithm and outputs a result corresponding to the convergence determination.

In addition, according to another embodiment of the invention, there is provided an image processing method performed in an image processing apparatus, including the steps of: allowing a high frequency estimator to generate difference image information between a low resolution image input as a processing object image of a super resolving process and a mid-processing image of the super resolving process or a processed image, that is, an initial image; and allowing a calculator to perform a process of updating the processed image through a process of calculation between the difference image information output from the step of allowing the high frequency estimator to generate the difference image information and the processed image, wherein in the step of allowing the high frequency estimator to generate the difference image information, a learning type data process using learned data is performed in the difference image information generating process.

In addition, according to still another embodiment of the invention, there is provided a program allowing an image processing apparatus to perform an image process, including steps of: allowing a high frequency estimator to generate difference image information between a low resolution image input as a processing object image of a super resolving process and a mid-processing image of the super resolving process or a processed image, that is, an initial image; and allowing a calculator to perform a process of updating the processed image through a process of calculation between the difference image information output from the step of allowing the high frequency estimator to generate the difference image information and the processed image, wherein in the step of allowing the high frequency estimator to generate the difference image information, a learning type data process using learned data is performed in the difference image information generating process.

In addition, the program according to the invention is a program which may be provided to, for example, an information processing apparatus or a computer system which can execute various types of program codes by a storage medium or a communication medium which is provided in a computer-readable format. The program is provided in a computer-readable format, so that a process according to the program can be implemented in the information processing apparatus or the computer system.

The other objects, features, and advantages of the invention will be clarified in more detailed description through the later-described embodiments of the invention and the attached drawings. In addition, in the specification, a system denotes a logical set configuration of a plurality of apparatuses, but the apparatus of each configuration is not limited to be in the same casing.

According to a configuration of an embodiment of the invention, there are provided an apparatus and method of generating a high resolution image by performing a process of combination of a reconstruction type super resolving process and learning type super resolving process. According to an embodiment of the invention, difference image information between a low resolution image which becomes a processing object of the super resolving process and a mid-processing image of the super resolving process or a processed image, that is, an initial image is generated, and a process of updating the processed image through a process of calculation between the difference image information and the processed image is performed to generate a high resolution image. In the high frequency estimator which generates the difference image, a learning type super resolving process using a learned data is performed. More specifically, for example, an upsampling process is performed as a learning type super resolving process. According to this configuration, defects of the reconstruction type super resolving process are solved, so that it is possible to generate a high-quality high resolution image.

### BRIEF DESCRIPTION OF THE DRAWINGS

FIG. 1 is a diagram illustrating a relationship between a low resolution image obtained in a photographing process of a camera and an ideal image which is an ideal high resolution image.

FIG. 2 is a diagram illustrating settings of parameters applied to an image process.

FIG. 3 is a diagram illustrating an example of a configuration of an image processing apparatus performing a super resolving process.

FIG. 4 is a diagram illustrating details of a configuration and process of a super resolving processor.

FIG. 5 is a diagram illustrating a detailed configuration and process of each of a plurality of the high frequency estimators set in the super resolving processor illustrated in FIG. 4.

FIG. 6 is a diagram illustrating a detailed configuration and process of an image quality controller set in the super resolving processor illustrated in FIG. 4.

FIG. 7 is a diagram illustrating a process of a scale calculator set in the super resolving processor illustrated in FIG. 4.

FIG. 8 is a diagram illustrating an example of a configuration of an image processing apparatus performing a reconstruction type super resolving process on a moving picture as a processing object.

FIG. 9 is a diagram illustrating a detailed configuration and process of a moving picture initial image generation unit illustrated in FIG. 8.

FIG. 10 is a diagram illustrating a configuration and process of a moving picture super resolving processor in an image processing apparatus performing the reconstruction type super resolving process illustrated in FIG. 8.

FIG. 11 is a diagram illustrating a detailed configuration and process of a moving picture high frequency estimator in the moving picture super resolving processor.

FIG. 12 is a diagram illustrating an overview of a configuration and process of an image processing apparatus performing a learning type super resolving method.

FIG. 13 is a diagram illustrating a learning process performing unit performing a learning process to generate the learned data.

FIG. 14 is a diagram illustrating details of an image feature amount extracting process performed by an image feature amount extractor illustrated in FIG. 13.

FIG. 15 is a diagram illustrating an example of a configuration and process of a learning type super resolving process performing unit performing a learning type super resolving process using the learned data.

FIG. 16 is a diagram illustrating an example of a configuration of an image processing apparatus according to a first embodiment of the invention.

FIG. 17 is a diagram illustrating a detailed configuration of a super resolving processor 503 in an image processing apparatus illustrated in FIG. 16.

FIG. 18 is a diagram illustrating a detailed configuration of a high frequency estimator in a super resolving processor illustrated in FIG. 17.

FIG. 19 is a diagram illustrating details of input/output data of a scale calculator and the peripheral calculators in the super resolving processor illustrated in FIG. 17.

FIG. 20 is a diagram illustrating a detailed configuration of a high frequency estimator in an image processing apparatus according to a second embodiment of the invention.

FIG. 21 is a diagram illustrating an example of a configuration of an image processing apparatus according to a third embodiment of the present invention.

FIG. 22 is a diagram illustrating a detailed configuration and process of a moving picture initial image generation unit illustrated in FIG. 21.

FIG. 23 is a diagram illustrating a configuration and process of a moving picture super resolving processor in an image processing apparatus illustrated in FIG. 21.

FIG. 24 is a diagram illustrating a detailed configuration and process of a moving picture high frequency estimator in a moving picture super resolving processor illustrated in FIG. 21.

FIG. 25 is a diagram illustrating a detailed configuration and process of a moving picture high frequency estimator of an image processing apparatus according to a fourth embodiment of the invention.

FIG. 26 is a diagram illustrating an example of a hardware configuration of an image processing apparatus according to the invention.

### DESCRIPTION OF THE PREFERRED EMBODIMENTS

Hereinafter, an image processing apparatus, an image processing method, and a program according to the invention will be described in detail with reference to the drawings. In addition, the description is made in the following order.

1. Description of Definition of Terminology Used in Description

2. Overview of Super Resolving Method

(2a) Overview of Reconstruction Type Super Resolving Method

(2b) Overview of Learning Type Super Resolving Method

(2c) Problems of Super Resolving Methods

3. Embodiments of Super Resolving Method According to the Invention

(3a) First Embodiment

(3b) Second Embodiment

(3c) Third Embodiment

4. Example of Hardware Configuration of Image Processing Apparatus

### 1. Description of Definition of Terminology Used in Description

First, definitions of terminology used in the following description are described before the description of the invention.

(Input Image)

An input image is an image actually photographed by an imaging device or the like and an image input to an image processing apparatus performing a super resolving process.

The input image is an image which is likely to have deterioration, for example, according to photographing conditions or the like, deterioration at the time of transmitting and recording, or the like. In general, the input image is a low resolution image.

(Output Image)

An output image is an image obtained as a result of performing a super resolving process on the input image in an image processing apparatus. In addition, the output image can be output as a high resolution image obtained by magnifying or reducing the input image with an arbitrary magnification ratio.

(Ideal Image)

An ideal image is an ideal image obtained in the case where quality deterioration and restrictions according to the photographing do not exist in the aforementioned input image. The ideal image is a target high resolution image which is a target to be acquired as a process result of the super resolving process.

(Reconstruction Type Super Resolving Method)

A reconstruction type super resolving method is an example of a method of a super resolving process in the related art. The reconstruction type super resolving method is a method of estimating a high resolution image as an ideal image from photographing conditions such as “blur caused by lens and atmosphere scattering”, “motion of a subject and the entire camera”, and “sampling by the imaging device”.

The reconstruction type super resolving process is configured by the following processes.

(a) An image photographing model is expressed by the equations by taking into consideration the blur, the motion, the sampling, and the like.

(b) A cost equation is obtained from the image photographing model. At this time, in some cases, regularized terms such pre-establishment may be added by using Bayes' theorem.

(c) An image for minimizing the cost is obtained.

Although the result depends on the input image, the super resolving effect (resolution recovering effect) is high.

(Learning Type Super Resolving Method)

The learning type super resolving method is a method of comparing an assumed input image (low resolution image) generated in a simulation or the like with an ideal image (high resolution image), generating the learned data for generating a high resolution image from a low resolution image, and converting a low resolution image as a new the input image to a high resolution image by using the learned data.

### 2. Overview of Super Resolving Method

Next, in the overview of the super resolving method of converting the low resolution image into the high resolution image, the following two methods are sequentially described.

(2a) Overview of Reconstruction Type Super Resolving Method

(2b) Overview of Learning Type Super Resolving Method

(2a) Overview of Reconstruction Type Super Resolving Method

First, the overview of the reconstruction type super resolving method is described.

The reconstruction type super resolving method is a method of generating one high resolution image by using a plurality of the low resolution images having, for example, a difference in position. An ML (Maximum-Likelihood) method or an MAP (Maximum A Posterior) method is known as a reconstruction type super resolving method.

Hereinafter, the overview of a general MAP method is described.

Herein, the case where n low resolution images are input and a high resolution image is generated is described.

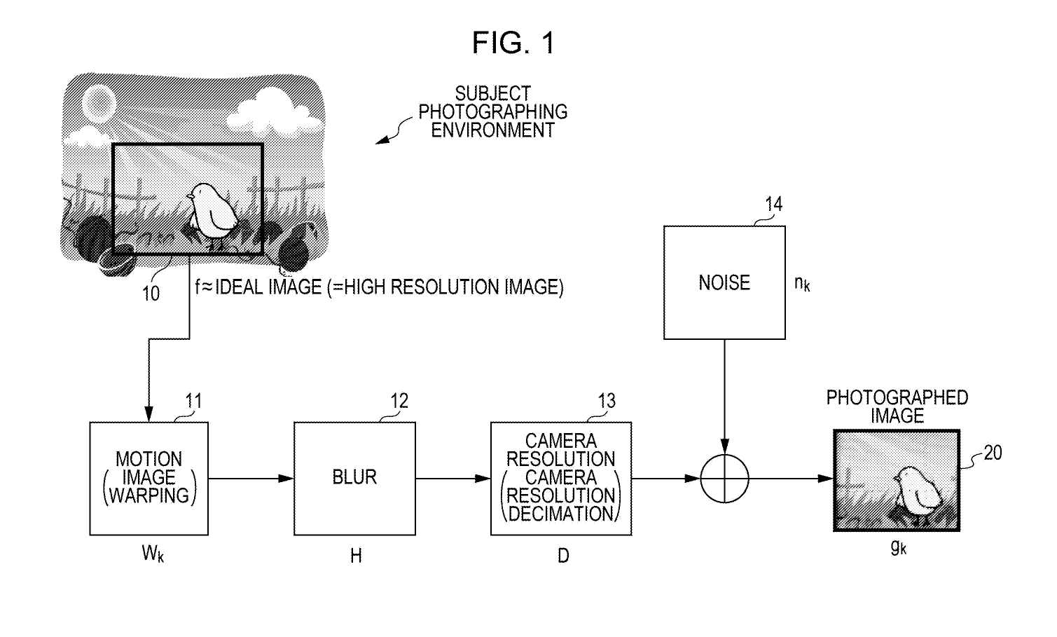

First, a relationship between the low resolution images (gₖ) obtained in a photographing process of a camera and an ideal image (f) which is an ideal high resolution image is described with reference to FIG. 1.

The ideal image (f) 10 may be referred to as an image having a pixel value corresponding to a real environment where a subject is photographed as illustrated in FIG. 1.

The images obtained by photographing of the camera are set to the low resolution images (gₖ) 20 as photographed images. In addition, the low resolution image (gₖ) 20 becomes the input image with respect to the image processing apparatus performing the super resolving process.

The low resolution image (gₖ) 20 which is the object of performance of the super resolving process and which is the photographed image may be referred to as an image formed when some portion of image information of the ideal image (f) 10 is lost due to various factors.

As main factors of loss in the image information, there are the following factors illustrated in FIG. 1.

Motion (image warping) 11 (=Wₖ),

Blur 12 (=H),

Camera resolution (Camera Resolution Decimation) 13 (=D),

Noise 14 (=nₖ)

The motion (Wₖ) 11 is a motion of the subject or a motion of the camera.

The blur (H) 12 is a blur caused by scattering in the atmosphere, frequency deterioration in an optical system of a camera, or the like.

The camera resolution (D) 13 is a limitation in the sampling data defined by the resolution (the number of pixels) of the imaging device of the camera.

The noise (nₖ) 14 is other noise, for example, a deterioration in image quality, or the like occurring in a signal process, or the like.

Due to the various factors, the image photographed by the camera becomes a low resolution image (gₖ) 20.

In addition, k indicates the k-th image among the images continuously photographed by the camera.

The blur (H) 12 and the camera resolution (D) 13 are not the parameters changed according to the photographing timing of the k-th image, but the motion (Wₖ) 11 and the noise (nₖ) 14 are the parameters changed according to the photographing timing.

In this manner, the low resolution image (gₖ) 20 which is the photographed image is image data formed when some portion of the image information of the ideal image (f) 10 is lost due to various factors. The correspondence relationship between the low resolution image (gₖ) 20 and the ideal image (f) 10 can be expressed by the following equation.

gₖ=DHWₖf+nₖ (Equation 1)

The above equation expresses that the low resolution image (gₖ) 20 which is the object of the performance of the super resolving process is generated by the deterioration in the motion (Wₖ), the blur (H), and the camera resolution (D) in the sampling and the addition of the noise (nₖ) in comparison with the ideal image (f) 10.

In addition, as data representing the input image (gₖ) and the ideal image (f), data expressing pixel values constituting each image may be used, and various expression can be set.

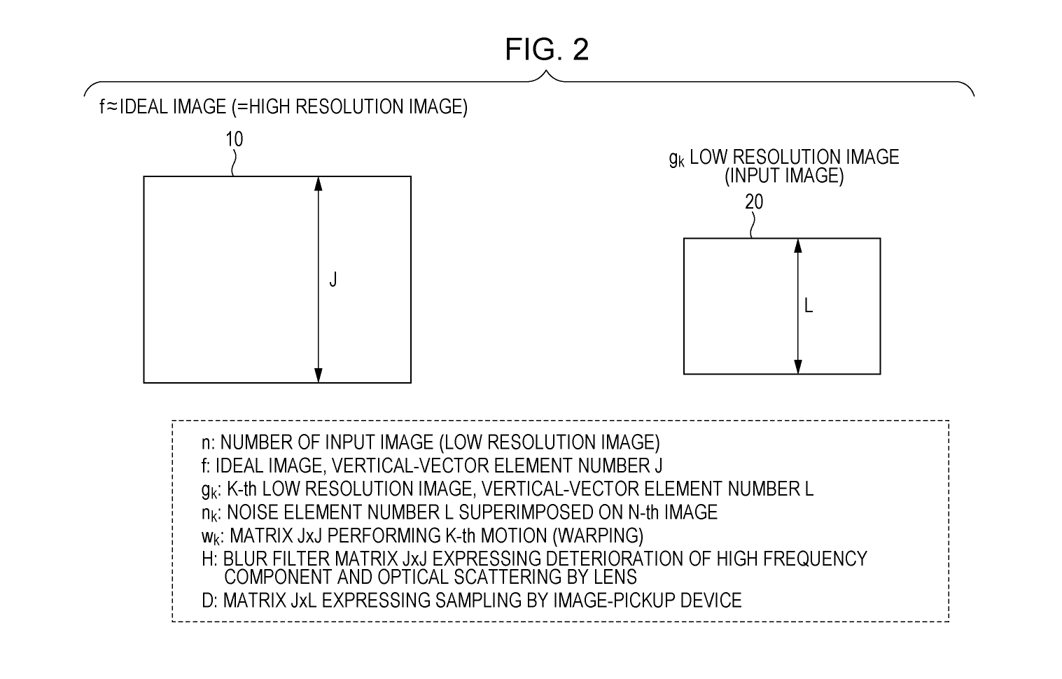

For example, as illustrated in FIG. 2, the data representing the input image (gₖ) and the ideal image (f) can be expressed by a vector of one vertical column of pixel values.

The input image (gₖ) is a vertical vector having the number of elements of L.

The ideal image (f) is a vertical vector having the number of elements of J.

The number of elements corresponds to the number of pixels in one vertical column.

Other parameters have the following configurations.

n: the number of images as input images (low resolution images)

f: an ideal image, a vertical vector (the number of elements J)

gₖ: a k-th low resolution image, a vertical vector (the number of elements L)

nₖ: noise (the number of elements L) overlapped with an n-th image

Wₖ: a matrix (J×J) performing a k-th motion (warping)

H: a blur filter matrix (J×J) expressing deterioration or optical scattering in a high frequency component by a lens

D: a matrix (J×L) expressing sampling by an imaging device

In the above equation (Equation 1), the motion (Wₖ), the blur (H), and the camera resolution (D) are acquirable parameters, that is, known parameters.

In this case, a process of calculating the ideal image (f) which is a high resolution image may be considered to be a process of calculating an image (f) having the highest probability according to the following equation by using a plurality (n) of the low resolution images (g₁) to (gₙ).

$$arg {max}_{f} Pr ( f \vert {g}_{1 ,} {g}_{2 , } … , {g}_{n} ) \qquad ( Equation 2 )$$

The above equation can be modified by using Bayes' theorem as follows.

$$Pr ( f \vert {g}_{1 ,} {g}_{2 ,} … , {g}_{n} ) = \frac{Pr ( {g}_{1 ,} {g}_{2 ,} … , {g}_{n} \vert f ) \cdot Pr ( f )}{Pr ( {g}_{1 ,} {g}_{2 ,} … , {g}_{n} )} \qquad ( Equation 3 )$$

Herein, a plurality (n) of the low resolution images (g₁) to (gₙ) are photographed images and known images. Therefore, the denominator Pr(g₁, g₂, . . . gₙ) of the above equation (Equation 3) becomes a constant number. Accordingly, the above equation can be expressed by using only the numerator as follows.

Pr(f|g₁,g₂, . . . gₙ)=Pr(g₁,g₂, . . . gₙ|f)·Pr(f). (Equation 4)

Furthermore, by taking logarithm on the both sides thereof, the above equation (Equation 4) can be modified into the following equation (Equation 5).

log(Pr(f|g₁,g₂, . . . gₙ))=log(Pr(g₁,g₂, . . . gₙ|f))+log(Pr(f)) (Equation 5)

Through a series of the modifications, the problem in the original equation (Equation 2) can be expressed as follows.

$$arg {max}_{f} Pr ( f \vert {g}_{1 ,} {g}_{2 ,} … , {g}_{n} ) = arg {max}_{f} ( log ( Pr ( {g}_{1 ,} {g}_{2 ,} … , {g}_{n} \vert f ) ) + log ( Pr ( f ) ) ) = arg {min}_{f} ( - ( log [ Pr ( {g}_{1 ,} {g}_{2 ,} … , {g}_{n} \vert f ) ] + log [ Pr ( f ) ] ) ) \qquad ( Equation 6 )$$

On the other hand, the noise nₖ of the k-th photographed image gₖ can be expressed according to the aforementioned equation (Equation 1) as follows.

nₖ=gₖ−DHWₖf (Equation 7)

Herein, if it is assumed that the noise has a Gauss distribution with a variance σ², Pr(g₁, g₂, . . . gₙ|f) in the aforementioned equation (Equation 6) can be expressed by the following equation (Equation 8).

$$Pr ( {g}_{1 ,} {g}_{2 ,} … , {g}_{n} \vert f ) = \frac{1}{\sqrt{2 π} σ} exp ( - {\sum }_{k = 1}^{n} {‖ {DHW}_{k} f - {g}_{k} ‖}^{2} / 2 {σ}^{2} ) \qquad ( Equation 8 )$$

In addition, under the assumption that the low resolution images (g₁) to (gₘ) input as photographed images are flat images, a preparatory probability of the image is defined as the following equation (Equation 9). Herein, L is the Laplacian operator.

Pr(f))=exp(−α·∥Lf∥²) (Equation 9)

By inserting these, the original problem, that is, the problem of calculation of the ideal image (f) can be defined as a process of obtaining (f) so that the cost, that is, E(f) is minimized in the following equation (Equation 10).

$$E ( f ) = {\sum }_{k = 1}^{n} {‖ {DHW}_{k} f - {g}_{k} ‖}^{2} + α Lf \qquad ( Equation 10 )$$

In the cost calculation equation (Equation 10), the (f) for minimizing the cost E(f) can be obtained by using a gradient method.

If f₀ is an arbitrary initial value and fₘ is an image after iteration of m image processes (super resolving processes), the following supper resolution convergence equation (Equation 11) can be defined.

$$\begin{matrix}{f}_{m + 1} = {f}_{m} - β \frac{\partial E ( {f}_{m} )}{\partial f} \\ = {f}_{m} - β ( \begin{matrix}{\sum }_{k = 1}^{n} {W}_{k}^{T} {H}^{T} {D}^{T} ( {DHW}_{k} {f}_{m} - {g}_{k} ) + \\ α {L}^{T} {Lf}_{m}\end{matrix} )\end{matrix} \qquad ( Equation 11 )$$

In the supper resolution convergence equation (Equation 11), α is an arbitrary user setting parameter in the image process (super resolving process). T represents a transpose matrix.

According to the above relational equation (Equation 11), the ideal image (f) for minimizing a cost E(f), that is, the high resolution image can be obtained by a gradient method.

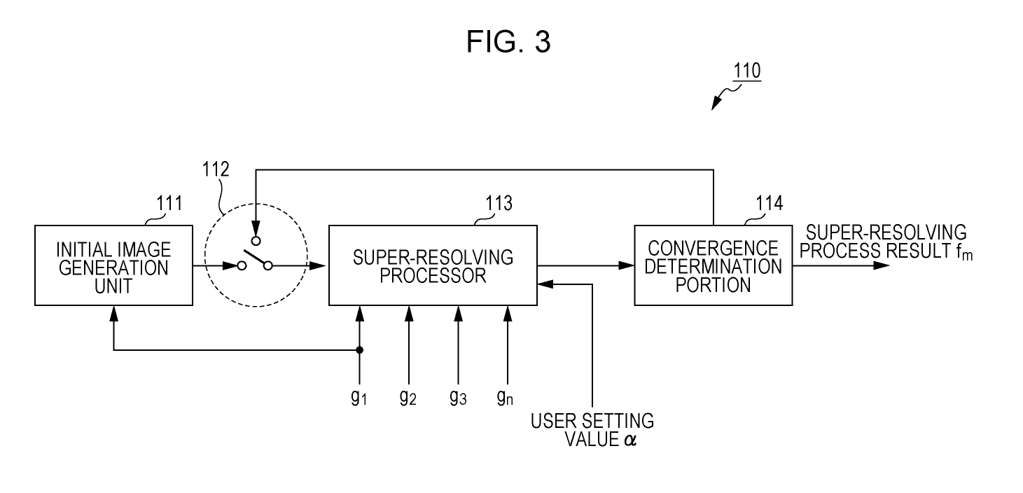

FIG. 3 illustrates an example of the configuration of the image processing apparatus 110 performing an image process for obtaining the ideal image (f) (=the high resolution image) of minimizing the cost E(f), that is, the super resolving process by a gradient method according to the supper resolution convergence equation (Equation 11).

The image processing apparatus 110 illustrated in FIG. 3 includes an initial image generation unit 111, a switch 112, a super resolving processor 113, and a convergence determination portion 114.

The image processing apparatus 110 is input with a plurality (n) of the low resolution images g₁ to gₙ and outputs one high resolution image fₘ.

The g₁, g₂, . . . gₙ illustrated in FIG. 3 indicate n low resolution input images.

The initial image generation unit 111 sets an initial value of the super resolving process result. The initial value may be an arbitrary value. In the embodiment, as an example, g₁ is input and an image where the g₁ is spread is output.

The switch 112 turns to the output side of the initial image generation unit 113 only at the time of first performance, and in other cases, the switch 112 is operated so that the previous-time output of the convergence determination portion 114 is input to the super resolving processor 113.

The super resolving processor 113 is input with the n low resolution images g₁, g₂, g₃ . . . gₙ and the image from the switch 112 and outputs the result to the convergence determination portion 114. Details of the super resolving processor 113 are described later.

The convergence determination portion 114 is input with the output of the super resolving processor 113 and determines whether or not sufficient convergence is performed. In the case where sufficient convergence is determined to be performed from the result of the super resolving processor 113, the convergence determination portion 114 outputs the result of the process to an external portion and stops the process. In the case where the process is determined to be insufficient, the above data are input through the switch 112 to the super resolving processor 113, and the calculation is performed again. For example, the convergence determination portion 114 extracts a difference between the newest process result and the previous-time process result, and in the case where the difference is equal to or smaller than a predetermined value, it is determined that the convergence is performed. Alternatively, in the case where the number of processes reaches a predetermined number of processes, it is determined that the convergence is performed, and the process result is output.

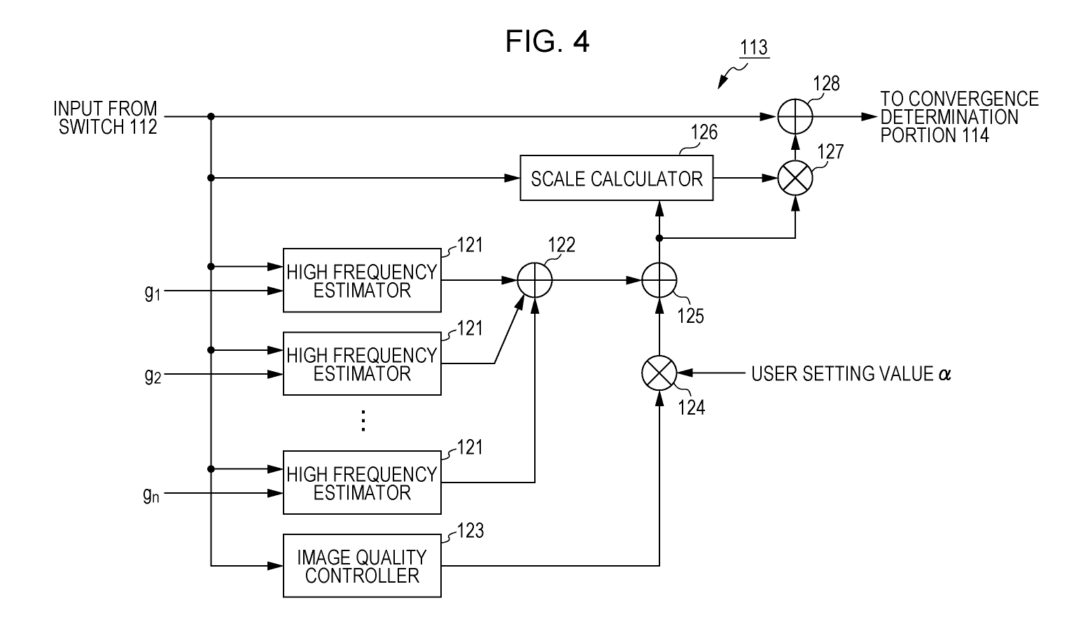

Details of a configuration and process of the super resolving processor 113 are described with reference to FIG. 4. As illustrated in FIG. 4, the super resolving processor 113 includes a plurality of high frequency estimators 121, an image quality controller 123, a scale calculator 126, and calculators such as adders 122, 125, and 128 and multipliers 124 and 127.

The super resolving processor 113 is input with the input from the switch 112 illustrated in FIG. 3, that is, a plurality (n) of the low resolution images g₁, g₂, . . . gₙ and outputs a process result to the convergence determination portion 114. In addition, the super resolving processor 113 is input with a user setting value a as an image adjustment parameter.

Each of the high frequency estimators 121 is input with an image as the mid-reconstruction result which is the input from the switch 112 and one of the low resolution images a g₁, g₂, . . . gₙ and outputs the process result to the adder 122. Each of the high frequency estimators 121 calculates a correction value for recovering the high frequency of the image. Details of the process of the high frequency estimator 121 are described later.

The adder 122 adds the results of the high frequency estimators 121 and outputs the process result to the adder 125.

The image quality controller 123 calculates a control value of the pixel value to be used for an ideal image based on a pre-establishment model of the image. The output of the image quality controller 123 is input to the multiplier 124.

The multiplier 124 multiplies the output of the image quality controller 123 with the user setting value α. The image quality of the final image is controlled according to the value of the user setting value α. In addition, in the configuration illustrated in the figure, the user setting value is taken so as to perform the control of the image quality. However, a fixed value may be used without occurrence of a problem.

The adder 125 adds the output of the adder 122 and the output of the multiplier 124 and outputs the calculation result to the scale calculator 126 and the multiplier 127. The scale calculator 126 is input with the mid-calculation result from the switch 112 and the pixel value control signal from the adder 125 to determine the scale value for the final control value. The result of the scale calculator 126 is output to the multiplier 127. The multiplier 127 multiplies the control value of the adder 125 with the output value of the scale calculator 126 and outputs the calculation result to the adder 128. The adder 128 subtracts the result of the multiplier 127 from the mid-processing result from the switch 112 and outputs the result to the convergence determination portion 114.

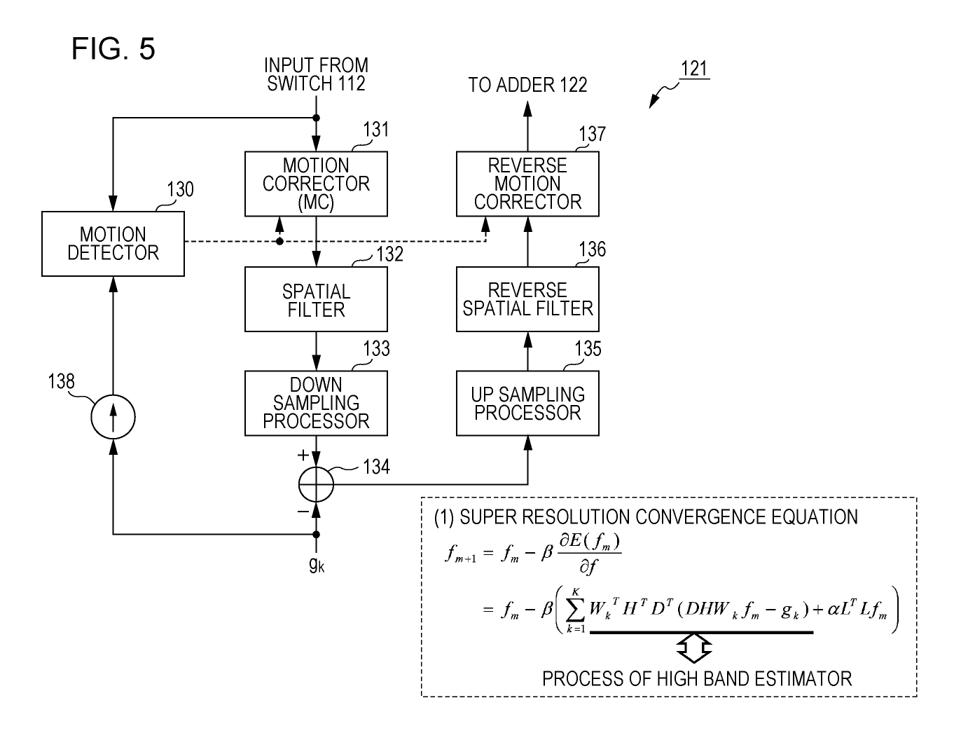

A detailed configuration and process of each of a plurality of the high frequency estimators 121 set in the super resolving processor 113 illustrated in FIG. 4 are described with reference to FIG. 5.

The high frequency estimator 121 performs a process corresponding to the lower line portion illustrated in (1) of FIG. 5 in the aforementioned supper resolution convergence equation (Equation 11).

The motion detector 130 is input with the high resolution image from the switch 112 and the low resolution image gₖ to detect a size of the motion between the two images. More specifically, the motion detector 130 calculates the motion vector.

In addition, as a preparation, since the motion is different between the two images, the resolution converter 138 constructed with, for example, an upsampling filter performs an upsampling process on the low resolution image gₖ, and performs a process of combining a resolution with a to-be-generated high resolution image.

The motion corrector (MC) 131 is input with the high resolution image from the switch 112 and the motion vector from the motion detector 130 and performs a transform on the input high resolution image. The process corresponds to the process of calculation of the motion (Wₖ) in the aforementioned supper resolution convergence equation (Equation 11) illustrated in (1) of FIG. 5.

The spatial filter 132 performs a process of simulation of the deterioration in the spatial resolution. Herein, convolution is performed on the image by using a pre-measured point spread function as a filter. The process corresponds to the process of calculation of the blur (H) in the aforementioned supper resolution convergence equation (Equation 11) illustrated in (1) FIG. 5.

The downsampling processor 133 performs a downsampling process on the high resolution image down to the resolution equal to that of the input image. The process corresponds to the process of calculation of the camera resolution (D) in the aforementioned supper resolution convergence equation (Equation 11) illustrated in (1) of FIG. 5.

After that, the subtractor 134 calculates the difference value for each pixel between the output of the downsampling processor 133 and the low resolution image gₖ.

The upsampling processor 135 performs an upsampling process of the difference value. The process corresponds to the process of calculation of the transpose matrix (D^{T}) of the camera resolution (D) in the aforementioned supper resolution convergence equation (Equation 11) illustrated in (1) of FIG. 5, and the upsampling process is performed in the zero-order hold.

The reverse spatial filter 136 performs a process corresponding to the process of calculation of the transpose matrix (H^{T}) of the blur (H) in the aforementioned supper resolution convergence equation (Equation 11) illustrated in (1) of FIG. 5. In terms of the operation, the process corresponds to the calculation of the correlation to the point spread function (PSF) used as the spatial filter 132.

The reverse motion corrector 137 performs reverse correction of the motion. The motion which is offset by the motion corrector 131 is applied to the difference value.

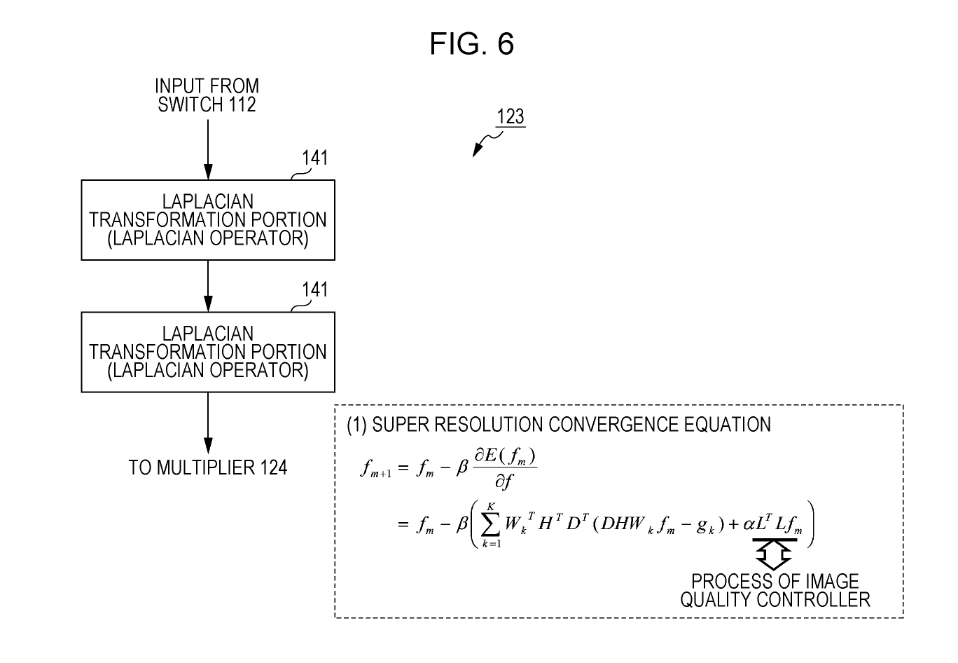

Next, a detailed configuration and process of the image quality controller 123 set in the super resolving processor 113 illustrated in FIG. 4 are described with reference to FIG. 6.

As illustrated in FIG. 6, the image quality controller 123 is configured with the Laplacian transformation portion 141.

The image quality controller 123 performs a process corresponding to the calculation process L^{T}Lfₘ, that is, the calculation in the lower line portion of the aforementioned supper resolution convergence equation (Equation 11) illustrated in (1) of FIG. 6.

The Laplacian transformation portion 141 applies the Laplacian operator (L) two times on the high resolution image (fₘ) input from the switch 112 illustrated in FIG. 3 and output the process result to the multiplier 124 illustrated in FIG. 4. In addition, since L=L^{T}, the calculation process L^{T}Lfₘ is performed by applying the Laplacian operator (L) two times.

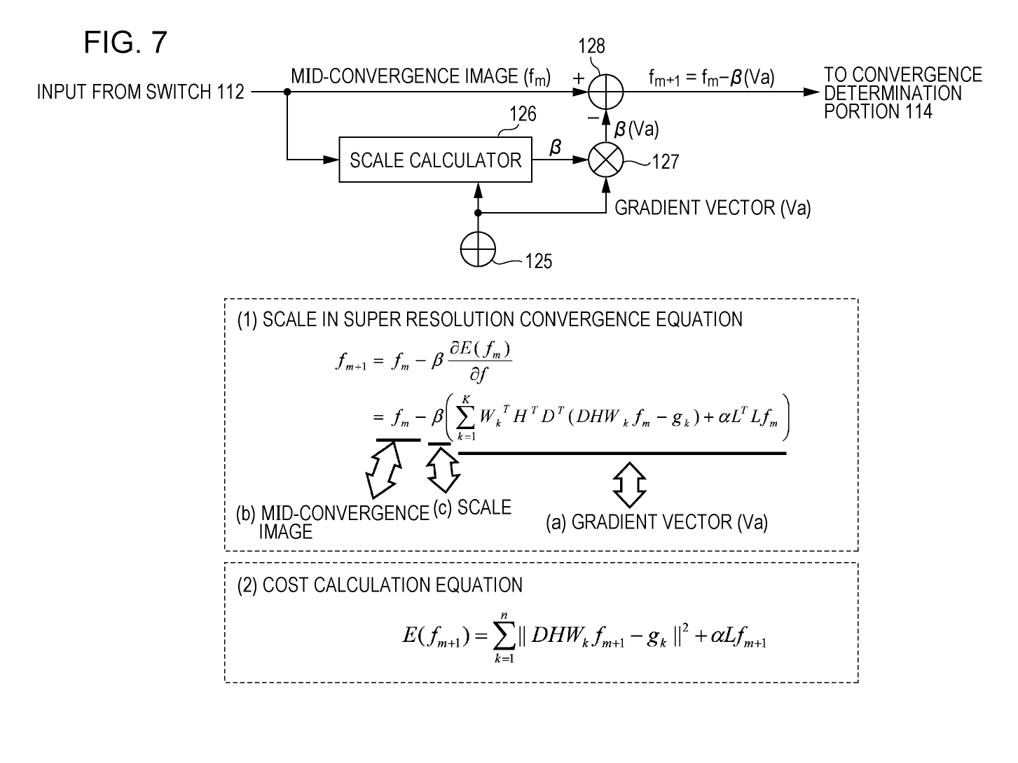

Next, a process of the scale calculator 126 set in the super resolving processor 113 illustrated in FIG. 4 is described with reference to FIG. 7.

The scale calculator 126 determines the scale (coefficient β) for the gradient vector in the image convergence calculation using a steepest descent method. In other words, the scale calculator 126 determines the coefficient β in the aforementioned supper resolution convergence equation (Equation 11) illustrated in (1) of FIG. 7. The coefficient β is a multiplication coefficient for the gradient vector (Va) in the aforementioned supper resolution convergence equation (Equation 11) illustrated in (1) of FIG. 7.

The scale calculator 126 is input with the gradient vector ((a) gradient vector (Va) in the aforementioned supper resolution convergence equation (Equation 11) illustrated in (1) of FIG. 7) from the adder 125 illustrated in FIG. 4 and receives the mid-converging image ((b) mid-converging image (fₘ) in the aforementioned supper resolution convergence equation (Equation 11) illustrated in (1) of FIG. 7) through the switch 112.

The scale calculator 126 obtains the coefficient β based on these inputs so that the cost E(fₘ₊₁) expressed in the cost calculation equation described as the aforementioned equation (Equation 10) illustrated in (2) of FIG. 7 is minimized.

As a process of calculation of the coefficient β, the coefficient β for the minimization is calculated by generally using a method such as binary search. In addition, in the case where the reduction in the cost of the calculation is desired, a configuration where a constant number is output regardless of an input may be used.

The result (β) of the scale calculator 126 is output to the multiplier 127. The multiplier 127 multiplies the gradient vector (Va) obtained as an output of the adder 125 with the output value (β) of the scale calculator 126 and outputs β(Va) to the adder 128. The adder 128 performs a process of subtracting β(Va), which is an input from the multiplier 127, from the super resolving processed image fₘ as the m-th super resolving process result, which is input as a mid-processing result of the super resolving process from the switch 112 and calculates the (m+1)-th super resolving process result fₘ₊₁.

In other words, fₘ₊₁=fₘ−β(Va).

The (m+1)-th super resolving process result fₘ₊₁ is calculated based on the above equation. This equation corresponds to the aforementioned supper resolution convergence equation (Equation 11) illustrated in (1) of FIG. 7.

The super resolving processor 113 outputs the (m+1)-th super resolving process result, that is, fₘ₊₁=fₘ−β(Va) to the convergence determination portion 114.

The convergence determination portion 114 is input with the (m+1)-th super resolving process result, that is, fₘ₊₁=fₘ−β(Va) from the super resolving processor 113 and determines based on the input whether or not sufficient convergence is performed. In the case where sufficient convergence is determined to be performed from the result of the super resolving processor 113, the convergence determination portion 114 outputs the result of the process to an external portion and stops the process. In the case where the process is determined to be insufficient, the above data are input through the switch 112 to the super resolving processor 113, and the calculation is performed again. For example, the convergence determination portion 114 extracts a difference between the newest process result and the previous-time process result, and in the case where the difference is equal to or smaller than a predetermined value, it is determined that the convergence is performed. Alternatively, in the case where the number of processes reaches a predetermined number of processes, it is determined that the convergence is performed, and the process result is output.

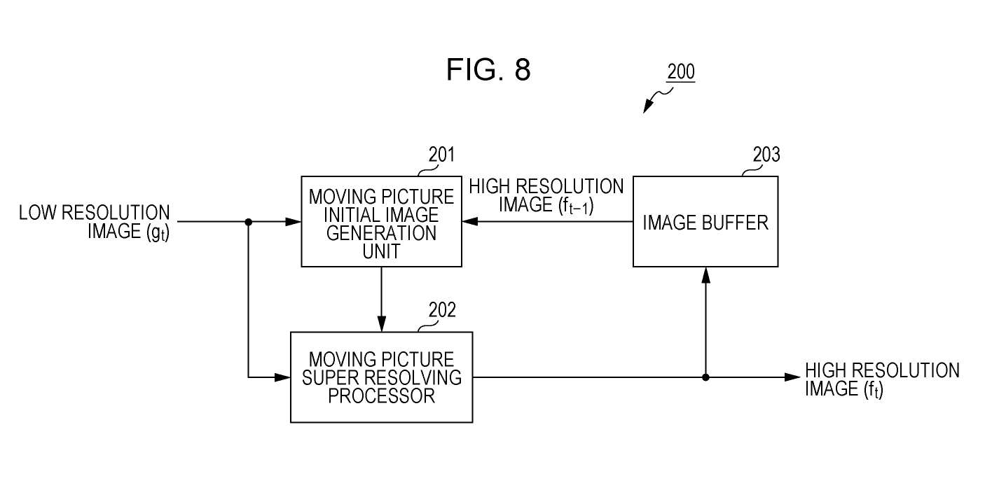

Next, a configuration and process of the image processing apparatus performing the reconstruction type super resolving process in the case where the processing object is specified to a moving picture are described with reference to FIG. 8 and the following figures. In addition, the image processing apparatus performing the reconstruction type super resolving process in the case where the processing object is specified as a moving picture is disclosed in Japanese Unexamined Patent Application Publication No. 2008-140012 which is a foregoing patent application filed by the same applicant as that of the present invention.

FIG. 8 illustrates an example of a configuration of the image processing apparatus 200 performing the reconstruction type super resolving process on a moving picture as a processing object.

As illustrated in FIG. 8, the image processing apparatus 200 includes a moving picture initial image generation unit 201, a moving picture super resolving processor 202, and an image buffer 203.

In the process for a moving picture, the following definitions are used.

gₜ: one frame of a low resolution moving picture at a time point t

fₜ: one frame of a high resolution moving picture at a time point t

In this manner, a low resolution image gₜ is set to one frame of the low resolution moving picture at a time point t, and a high resolution image fₜ is the high resolution image obtained as a result of the super resolving process applied on the low resolution image gₜ.

In the image processing apparatus 200 performing the reconstruction type super resolving process illustrated in FIG. 8, the low resolution image gₜ is input to the moving picture initial image generation unit 201 and the moving picture super resolving processor 202.

The moving picture initial image generation unit 201 is input with the previous-frame moving picture super resolving process results (fₜ₋₁) and (gₜ) and outputs the generated initial image to the moving picture super resolving processor 202. Details of the moving picture initial image generation unit 201 are described later.

The moving picture super resolving processor 202 generates the high resolution image (fₜ) by applying the low resolution image (gₜ) to the input initial image and outputs the high resolution image (fₜ). Details of the moving picture super resolving processor 202 are described later.

The high resolution image output from the moving picture super resolving processor 202 is output to the image buffer 203 at the same time of being output to an external portion, so that the high resolution image is used for the super resolving process for the next frame.

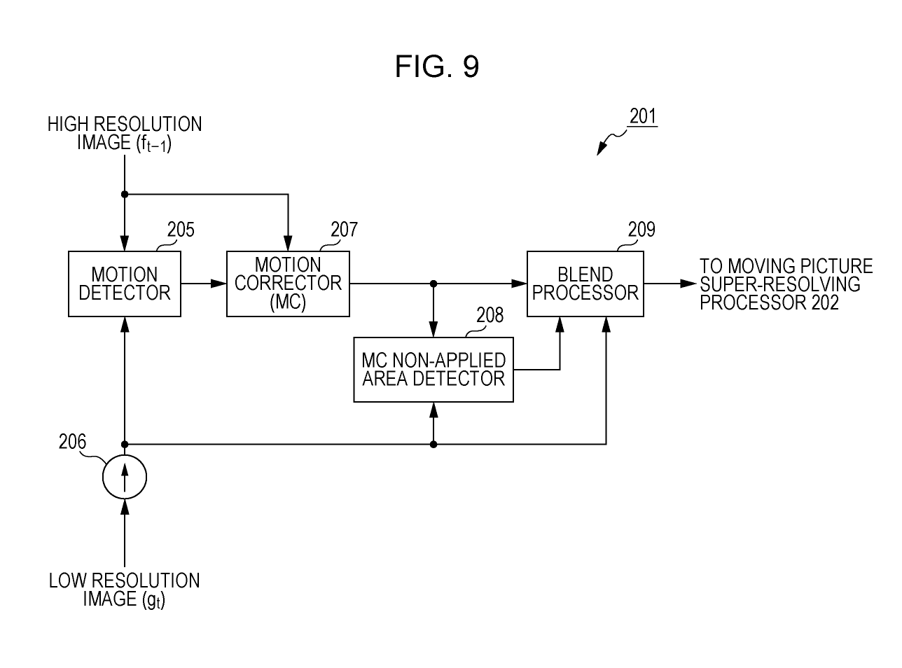

Next, a detailed configuration and process of the moving picture initial image generation unit 201 are described with reference to FIG. 9. The moving picture initial image generation unit 201 is input with the previous-frame moving picture super resolving process results (fₜ₋₁) and (gₜ) and outputs the generated initial image to the moving picture super resolving processor 202.

First, a process of combining the resolution of the low resolution image gₜ and the resolution of the to-be-generated high resolution image is performed by performing the upsampling process by the resolution converter 206 constructed with, for example, an upsampling filter.

The motion detector 205 detects a size of the motion between the previous-frame high resolution image fₜ₋₁ and the upsampled low resolution image gₜ. More specifically, the motion detector 205 calculates the motion vector.

In the motion corrector (MC) 207, the motion corrector (MC) 207 performs a motion correction process on the high resolution image fₜ₋₁ by using the motion vector detected by the motion detector 205. Therefore, the motion correction is performed on the high resolution image fₜ₋₁, so that a motion correction image where a position of the subject is set to be the same as that in the upsampled low resolution image gₜ is generated.

The MC non-applied area detector 208 detects an area where the motion correction (MC) is not well applied by comparing the high resolution image generated by the motion correction (MC) process with the upsampled low resolution image. The MC non-applied area detector 208 sets appropriateness information α [0:1] of MC application in units of a pixel and outputs the appropriateness information.

The blend processor 209 is input with the motion correction resulting image for the high resolution image fₜ₋₁, which is generated by the motion corrector (MC) 207, the upsampled image which is obtained by upsampling the low resolution image gₜ in the resolution converter 206, and the MC non-applied area detection information which is detected by the MC non-applied area detector 208.

The blend processor 209 outputs the moving picture super resolution initial image as a blend result based on the following equation by using the above input information.

moving picture super resolution initial image(blend result)=(1−α)(upsampled image)+α(motion correction resulting image)

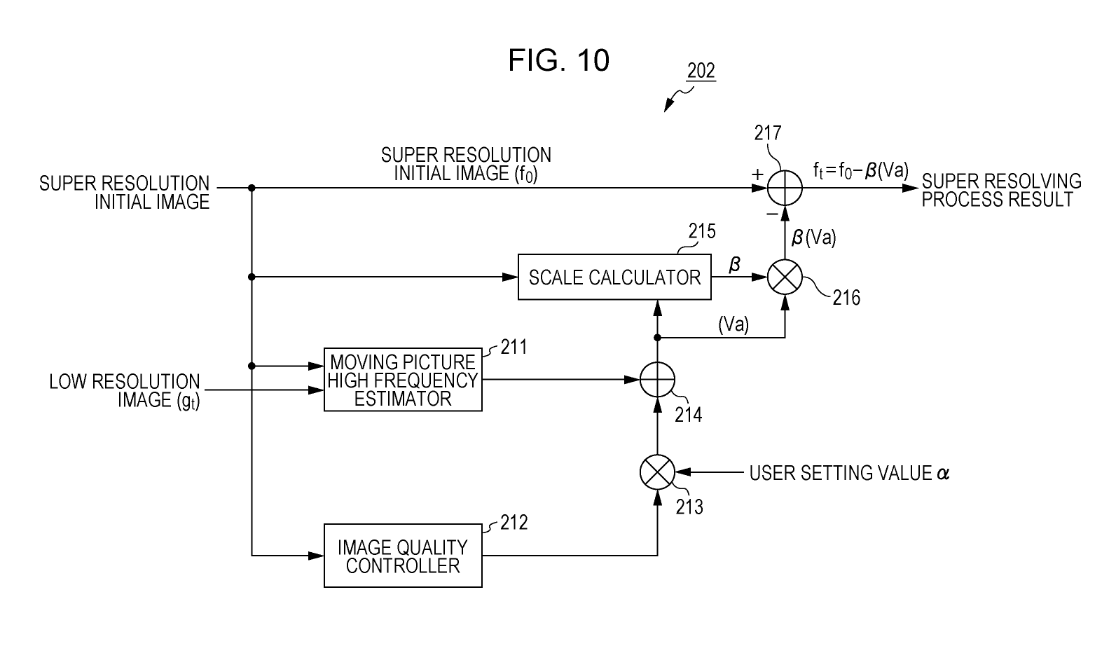

Next, a configuration and process of the moving picture super resolving processor 202 in the image processing apparatus 200 performing the reconstruction type super resolving process illustrated in FIG. 8 are described with reference to FIG. 10.

FIG. 10 illustrates a block diagram of the moving picture super resolving processor 202. The moving picture super resolving processor 202 has the same configuration as that of the super resolving processor 113 performing the super resolving process on a still image described above with reference to FIG. 4 except that the high frequency estimator is constructed with one moving picture high frequency estimator 211.

As illustrated in FIG. 10, the moving picture super resolving processor 202 includes a moving picture high frequency estimator 211, an image quality controller 212, a scale calculator 215, and calculators such as adders 214 and 217 and multipliers 213 and 216.

The moving picture super resolving processor 202 is input with the moving picture super resolution initial image as the aforementioned blend result from the moving picture initial image generation unit 201 illustrated in FIG. 8. In other words, the moving picture super resolving processor 202 is input with the result of the blending, that is, “moving picture super resolution initial image (blend result)=(1−α)(upsampled image)+α(motion correction resulting image)”.

Furthermore, the moving picture super resolving processor 202 is input with the low resolution image gₜ and the user setting value α as an image adjustment parameter to generate the high resolution image (fₜ) as a process result and outputs the high resolution image (fₜ).

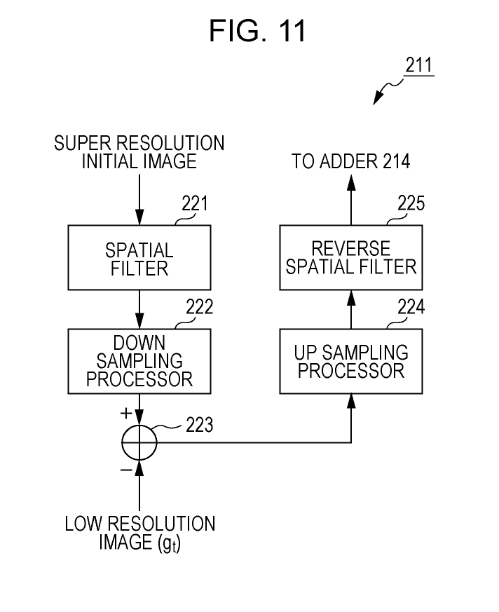

A detailed configuration and process of the moving picture high frequency estimator 211 in the moving picture super resolving processor 202 are described with reference to FIG. 11. Similarly to the high frequency estimator 121 corresponding to the still image described above with reference to FIG. 5, the moving picture high frequency estimator 211 calculates a correction value for recovering the high frequency of the image.

Unlike the high frequency estimator 121 corresponding to the still image described above with reference to FIG. 5, the moving picture high frequency estimator 211 does not include a motion detector, a motion corrector, and a reverse motion corrector. However, similarly to the high frequency estimator 121 corresponding to the still image, the moving picture high frequency estimator 211 calculates the correction value for recovering the high frequency of the image.

The moving picture high frequency estimator 211 is input with the moving picture super resolution initial image as the aforementioned blend result generated by the moving picture initial image generation unit 201 and the low resolution image (gₜ) and outputs the process result to the adder 214.

The spatial filter 211 illustrated in FIG. 11 is input with the moving picture super resolution initial image as the aforementioned blend result generated by the moving picture initial image generation unit 201 and performs a process of simulation of the deterioration in the spatial resolution. Herein, convolution is performed on the image by using a pre-measured point spread function as a filter. The process corresponds to the process (refer to (1) of FIG. 5) of calculation of the blur (H) in the aforementioned supper resolution convergence equation (Equation 11).

The downsampling processor 222 performs a downsampling process on the high resolution image down to the resolution equal to that of the input image. The process corresponds to the process (refer to (1) of FIG. 5) of calculation of the camera resolution (D) in the aforementioned supper resolution convergence equation (Equation 11).

After that, the subtractor 223 calculates the difference value for each pixel between the output of the downsampling processor 222 and the low resolution image gₜ.

The upsampling processor 224 performs an upsampling process on the difference value. The process corresponds to the process (refer to (1) of FIG. 5) of calculation of the transpose matrix (D^{T}) of the camera resolution (D) in the aforementioned supper resolution convergence equation (Equation 11), and the upsampling process is performed in the zero-order hold.

The reverse spatial filter 225 performs a process corresponding to the process ((1) of FIG. 5) of calculation of the transpose matrix (H^{T}) of the blur (H) in the aforementioned supper resolution convergence equation (Equation 11). In terms of the operation, the process corresponds to the calculation of the correlation to the point spread function (PSF) used as the spatial filter 221. The output of the reverse spatial filter 225 is output to the adder 214.

In the moving picture super resolving processor 202 illustrated in FIG. 10, the other configurations, that is, the image quality controller 212 and the scale calculator 215 perform the same processes as those of the image quality controller 123 (refer to FIG. 6) and the scale calculator 126 (refer to FIG. 7) of the super resolving processor 113 corresponding to the still image.

In other words, as illustrated in FIG. 6 described above, the image quality controller 212 is configured with the Laplacian transformation portion 141 and performs the calculation in the lower line portion of the aforementioned supper resolution convergence equation (Equation 11) illustrated in (1) of FIG. 6, that is, a process corresponding to the calculation process L^{T}Lfₘ.

The Laplacian transformation portion is input with the moving picture super resolution initial image as the aforementioned blend result generated by the moving picture initial image generation unit 201 and applies the Laplacian operator (L) two times on the moving picture super resolution initial image to output the process result to the multiplier 213 illustrated in FIG. 10.

The scale calculator 215 determines the scale for the gradient vector in the image convergence calculation using a steepest descent method. In other words, the scale calculator 215 determines the coefficient β in the aforementioned supper resolution convergence equation (Equation 11) illustrated in (1) of FIG. 7.

The scale calculator 215 is input with the gradient vector ((a) gradient vector in the aforementioned supper resolution convergence equation (Equation 11) illustrated in (1) of FIG. 7) from the adder 214 illustrated in FIG. 10 and further input with the moving picture super resolution initial image as the aforementioned blend result generated by the moving picture initial image generation unit 201.

The scale calculator 215 obtains the coefficient β based on these inputs so that the cost E(fₘ₊₁) expressed in the cost calculation equation described as the aforementioned equation (Equation 10) illustrated in (2) of FIG. 7 is minimized.

As a process of calculation of the coefficient β, the coefficient β for the minimization is calculated by generally using a method such as binary search. In addition, in the case where the reduction in the cost of the calculation is desired, a configuration where a constant number is output regardless of an input may be used.

As a result, the coefficient β by which the minimum cost can be set is determined. The subsequent processes are the same as processes described above with reference with FIG. 7 as an example of the processes corresponding to the still image.

In other words, the result (β) of the scale calculator 215 illustrated in FIG. 10 is output to the multiplier 216. The multiplier 216 multiplies the gradient vector (Va) (refer to (1) of FIG. 7) obtained as an output of the adder 214 with the output value (β) of the scale calculator 215 and outputs β(Va) to the adder 217. The adder 217 performs a process of subtracting β(Va), which is an input from the multiplier 216, from the moving picture super resolution initial image f₀ as the aforementioned blend result generated by the moving picture initial image generation unit 201 and outputs the super resolving process result fₜ.

In other words, fₜ=f₀−β(Va)

The super resolving process result fₜ is calculated based on the above equation. This equation corresponds to the aforementioned supper resolution convergence equation (Equation 11) illustrated in (1) of FIG. 7.

The moving picture super resolving processor 202 outputs the super resolving process result and stores the super resolving process result to the image buffer 203.

(2b) Overview of Learning Type Super Resolving Method

Next, the overview of the learning type super resolving method is described.

The learning type super resolving method is a method of comparing an assumed input image (low resolution image) generated through simulation or the like with an ideal image (high resolution image), generating learned data for generating the high resolution image from the low resolution image, and converting a low resolution image as a new input image into a high resolution image by using the learned data.

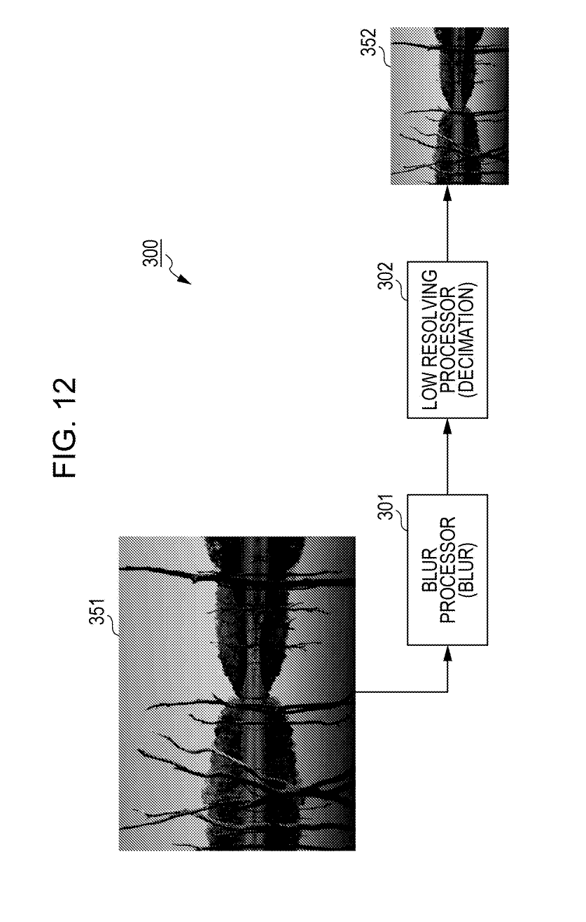

The overview of a configuration and process of an image processing apparatus performing the learning type super resolving method is described with reference to FIG. 12 and the following figures.

In the case where the learning type super resolving process is performed, as a preparation, the learned data are necessarily generated. First, the learning data generating process is described with reference to FIG. 12.

FIG. 12 illustrates an example of a configuration of learning data generating unit 300.

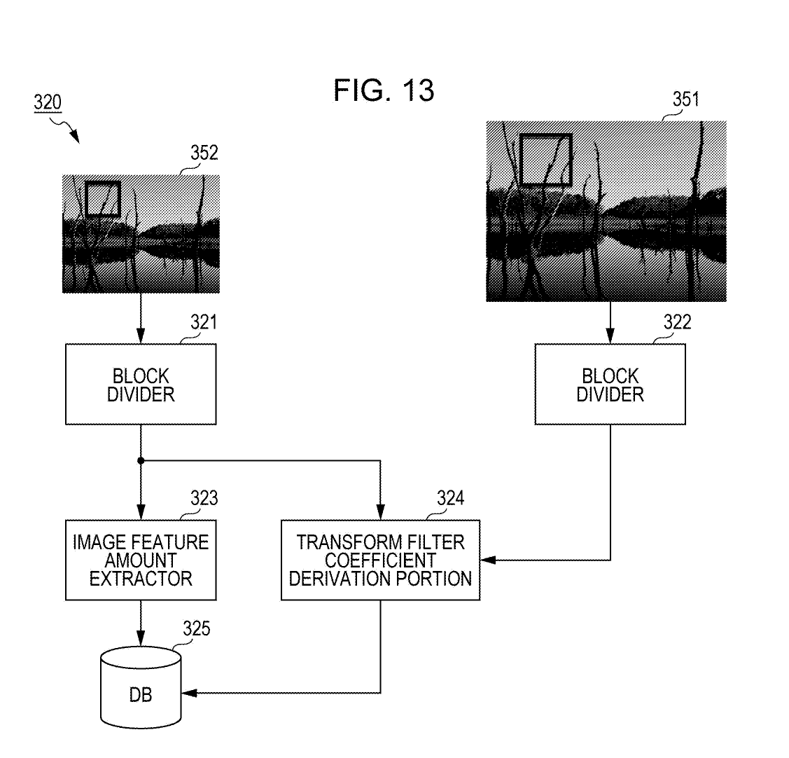

The learning data generating unit 300 is input with the ideal image 351 as a high resolution image and generates the low resolution image 352 as a virtual deteriorated image. The ideal image 351 and the low resolution image 352 are treated as data for the learning. For example, the learning process performing unit 320 illustrated in FIG. 13 performs a learning process by using the above data to generate the learned data.

As illustrated in FIG. 12, the learning data generating unit 300 includes a blur processor (blur) 301 and the low resolving processor (decimation) 302. The blur processor (blur) 301 is input with the ideal image 351 as a high resolution image to perform a blur process, and the low resolving processor (decimation) 302 performs a low resolving process to generate the low resolution image 352 as a virtual deteriorated image.

Many combinations of the ideal image 351 as a high resolution image and the low resolution image 352 as a virtual deteriorated image are generated, and the learning process is performed by using the combinations in the learning process performing unit 320 illustrated in FIG. 13, so that the learned data are generated.

The learning process of the learning process performing unit 320 is described with reference to FIG. 13.

The learning process performing unit 320 is sequentially input with the image pairs of the ideal image 351 and the low resolution image 352 generated by the learning data generating unit 300, generates the learned data, and stores the learned data in database (DB) 325.

The block dividers 321 and 322 perform dividing of blocks (localized area) corresponding to the ideal image 351 and the low resolution image 352.

The image feature amount extractor 323 extracts the image feature of the block (localized area) selected from the low resolution image 352. Details of the extracting process are described later.

The transform filter coefficient derivation portion 324 is input with the corresponding blocks extracted from the ideal image 351 and the low resolution image 352 and calculates an optimal transform filter coefficient (filter tap or the like) for performing a spreading process for generating the ideal image 351 from the low resolution image 352.

The database (DB) 325 stores the image feature amount in units of a block generated by the image feature amount extractor 323 and the transform filter coefficient generated by the transform filter coefficient derivation portion 324.

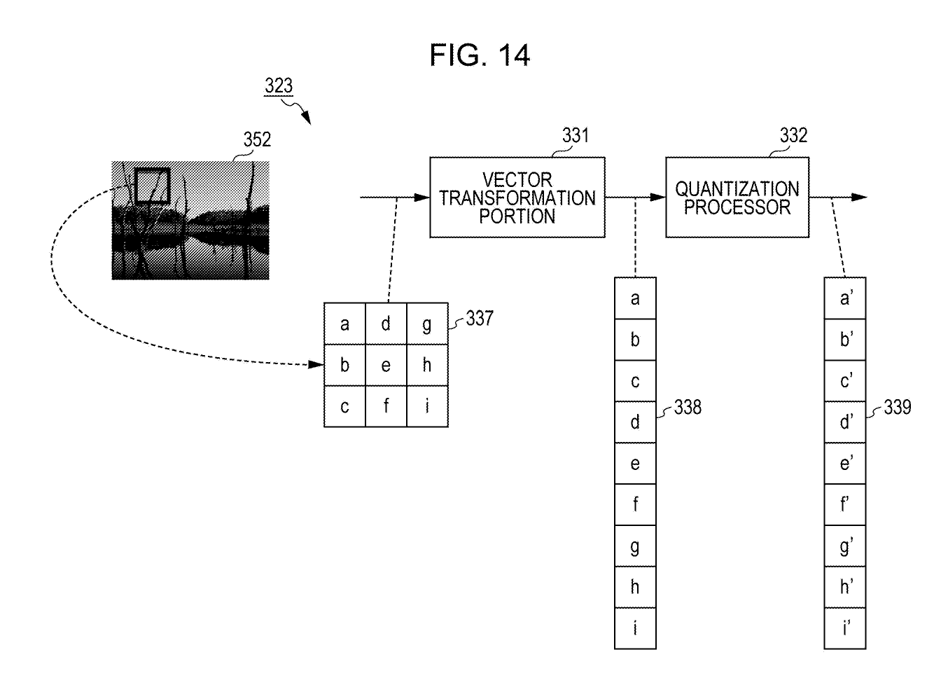

Details of the image feature amount extracting process performed by the image feature amount extractor 323 are described with reference to FIG. 14. As illustrated in FIG. 14, the image feature amount extractor 323 includes a vector transformation portion 331 and a quantization processor 332.

The vector transformation portion 331 converts the block image 337 which is the localized area image data of the low resolution image 352 selected by the block divider 321 into a one-dimensional vector 338.

Furthermore, the quantization processor 332 performs conversion such as quantization on each vector element of the one-dimensional vector 338 to generate a quantized vector 339. The value obtained by the calculation is set to the feature amount of the localized image (block). The feature amount data are stored as learned data in the database 325.

The quantized vectors which are the feature amount data in units of a block and the data corresponding to the transform filter coefficient corresponding to the block are stored in the database (DB) 325.

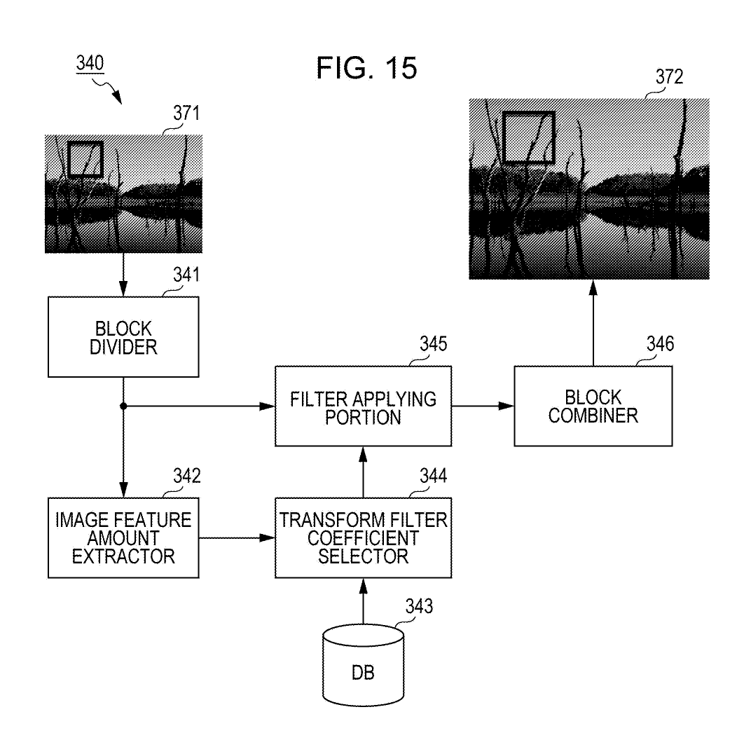

Next, a configuration and process of the learning type super resolving process performing unit performing the learning type super resolving process using the learned data are described with reference to FIG. 15.

The learning type super resolving process performing unit 340 illustrated in FIG. 15 is input with the low resolution image 371 which is the object of the performance of the super resolving process, performs the super resolving process using the learned data stored in the database 343 to generate the high resolution image 372, and outputs the high resolution image 372.

First, the block divider 341 is input with the low resolution image 371 which is the object of the performance of the super resolving process and divides the blocks (small areas).

The image feature amount extractor 342 extracts the image feature amount in units of a block. The feature amount is the same quantized vector data as those described with reference to FIG. 14.

The transform filter coefficient selector 344 searches for the data that are most similar to the feature amount (quantized vector data) corresponding to the block extracted by the image feature amount extractor 342 from the input data of the database (DB) 343.

The database (DB) 343 corresponds to the database 325 described with reference to FIG. 13. The database (DB) 343 is the database storing the quantized vector, which is the feature amount data in units of a block, and the data corresponding to the transform filter coefficient corresponding to the block.

The transform filter coefficient selector 344 selectively extracts the transform filter coefficient, which is in correspondence with the data having the maximum likelihood with respect to the feature amount (quantized vector data) corresponding to the block extracted by the image feature amount extractor 342, from the database 343 and outputs the transform filter coefficient to filter applying portion 345.

The filter applying portion 345 performs a data transform process by using a filter process set with the transform filter coefficient supplied from the transform filter coefficient selector 344 and generates a localized image which becomes a constituting block of the high resolution image 372.

The block combiner 346 combines the blocks sequentially output from the filter applying portion 345 to generate the high resolution image 372.

In this manner, in the high resolution image generating process using the learning type super resolving process, the assumed input image (low resolution image) generated in a simulation or the like is compared with the ideal image (high resolution image), the learned data for generating the high resolution image from the low resolution image are generated, and the low resolution image as a new input image is converted into the high resolution image by using the learned data.

(2c) Problems of Super Resolving Methods

As described above, as a method of generating a high resolution image from a low resolution image, there are the following methods.

(a) Reconstruction Type Super Resolving Method

(b) Learning Type Super Resolving Method

However, with respect to the reconstruction type super resolving method (a), although high performance can be generally expected, there are restrictions as follows

“A plurality of the low resolution images is necessarily input.”

“There is a limitation in the frequency band of the input image, or the like.”

In the case where the input image (low resolution image) which does not satisfy these restrictive conditions may not be obtained, there is a problem in that the reconstruction performance may not be sufficiently obtained and the sufficient high resolution image may not be generated.

In this manner, since the reconstruction type super resolving method is based on the use of a plurality of images, the effect thereof is limited in the case where there is a single input image or a small number of input images.

In addition, in the reconstruction type super resolving method, the following processes are performed in terms of a practical effect.

(a) Component estimation for high frequency component (equal to or higher than the Nyquist frequency) based on aliasing component (aliasing) in the input screen

(b) Elimination of aliasing component (aliasing) in low frequency component (equal to or lower than the Nyquist frequency) and recovery of high frequency component (equal to or higher than the Nyquist frequency)

However, in the case where there are a small number of the input images, there is a problem in that the estimation of the aliasing component (aliasing) is not appropriately performed. In addition, even in the case where the aliasing component may not be detected in the input image caused by an extreme deterioration of the input image, similarly, there is a case where the high frequency performance is insufficient.

Therefore, in the reconstruction type super resolving method, in the case where a plurality of the input images is used and aliasing distortion occurs caused by the sampling, a great effect can be expected. However, in the case where there are a small number of the input images or in the case where there is no aliasing distortion in the input image, there is a disadvantages in that a resolution improvement effect is low.

On the other hand, with respect to the learning type super resolving method (b), although the restriction caused by the number of the input images and the properties of the input image is low and stabilized, there is a problem in that the peak performance of the finally-obtained high resolution image does not reach the reconstruction type super resolution.

In the learning type super resolving method (b), in the case where the learned data are sufficient and reference information at the time of selecting the learned data is sufficient, a great effect can be obtained.

However, practically, there are restrictions as follows.

Upper limit of the data amount of the learned data

Limitation in the reference information at the time of selecting the learned data

Due to these restrictions, in the learning type super resolving method, a final high resolution image is generated as a result of combination of the processes in units of a block, so that whole balance may be deteriorated. Therefore, there is a case where a sufficient resolution improvement effect may not be obtained.

### 3. Embodiments of Super Resolving Method According to the Invention

Hereinafter, embodiments of the super resolving method according to the invention are described. The image processing apparatus according to the invention implements the super resolving method using advantages of the reconstruction type super resolving method and the learning type super resolving method. First, the overview of the super resolving process according to the invention is described.

The image processing apparatus according to an embodiment of the invention performs a process the following supper resolution convergence equation (Equation 12) which is obtained by modifying the supper resolution convergence equation described as the aforementioned equation (Equation 11).

$$\begin{matrix}{f}_{m + 1} = {f}_{m} - β ( \begin{matrix}{\sum }_{k = 1}^{n} {W}_{k}^{T} {H}^{T} {D}^{T} ( {DHW}_{k} {f}_{m} - {g}_{k} ) + \\ α {L}^{T} {Lf}_{m}\end{matrix} ) \\ = {f}_{m} - β ( \begin{matrix}{\sum }_{k = 1}^{n} ( \begin{matrix}{W}_{k}^{T} {H}^{T} {D}^{T} {DHW}_{k} {f}_{m} - \\ {W}_{k}^{T} {H}^{T} {D}^{T} {g}_{k}\end{matrix} ) + \\ α {L}^{T} {Lf}_{m}\end{matrix} ) \\ = {f}_{m} - β ( \begin{matrix}{\sum }_{k = 1}^{n} ( {W}_{k}^{T} {H}^{T} {D}^{T} {DHW}_{k} {f}_{m} ) - \\ {\sum }_{k = 1} ( {W}_{k}^{T} {H}^{T} {D}^{T} {g}_{k} ) + α {L}^{T} {Lf}_{m}\end{matrix} )\end{matrix} \qquad ( Equation 12 )$$

In the supper resolution convergence equation (Equation 12), α is an arbitrary user setting parameter in an image process (super resolving process). T represents a transpose matrix.

According to the above relational equation (Equation 12), the ideal image (f) for minimizing a cost E(f) can be obtained by a gradient method.

In the supper resolution convergence equation (Equation 12), (H^{T}D^{T}) and (DH) have the meaning corresponding to the execution of the following processes as processes of the image processing apparatus.

DH: Process of applying downsampling filter

H^{T}D^{T}: Process of applying upsampling filter

Simple downsampling and upsampling processes which are calculated from the model equation expressed in the aforementioned supper resolution convergence equation (Equation 12) derive mathematically correct results. However, there is a case where these results are not necessarily coincident with subjective estimation.

In the invention, the simple downsampling process calculated from the model equation is replaced with a reducing process using the learned data, and the upsampling process is replaced with a spreading process using the same learned data or a learning type super resolving process, so that the subjective result of the super resolving result is improved. By using this method, in the case where the number of input images is small or even in the case where the input image is extremely deteriorated, the effect of image quality improvement can be expected.

Hereinafter, the super resolving processes according to a plurality of embodiments (first to third embodiments) of the invention are sequentially described.

### (3a) First Embodiment

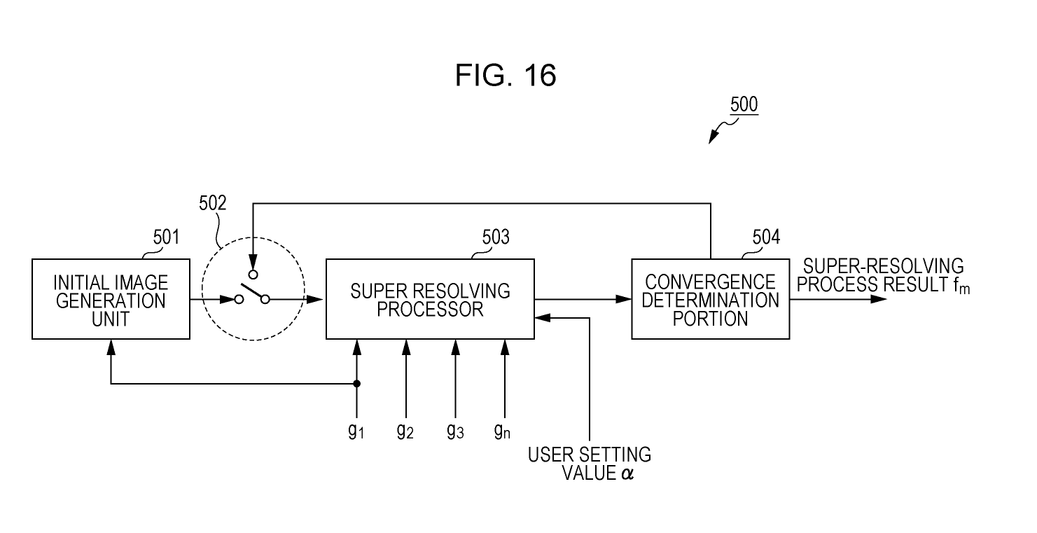

First, an image processing apparatus according to a first embodiment of the invention is described with reference to FIGS. 16 to 19.

FIG. 16 is a diagram illustrating a whole configuration of an image processing apparatus 500.

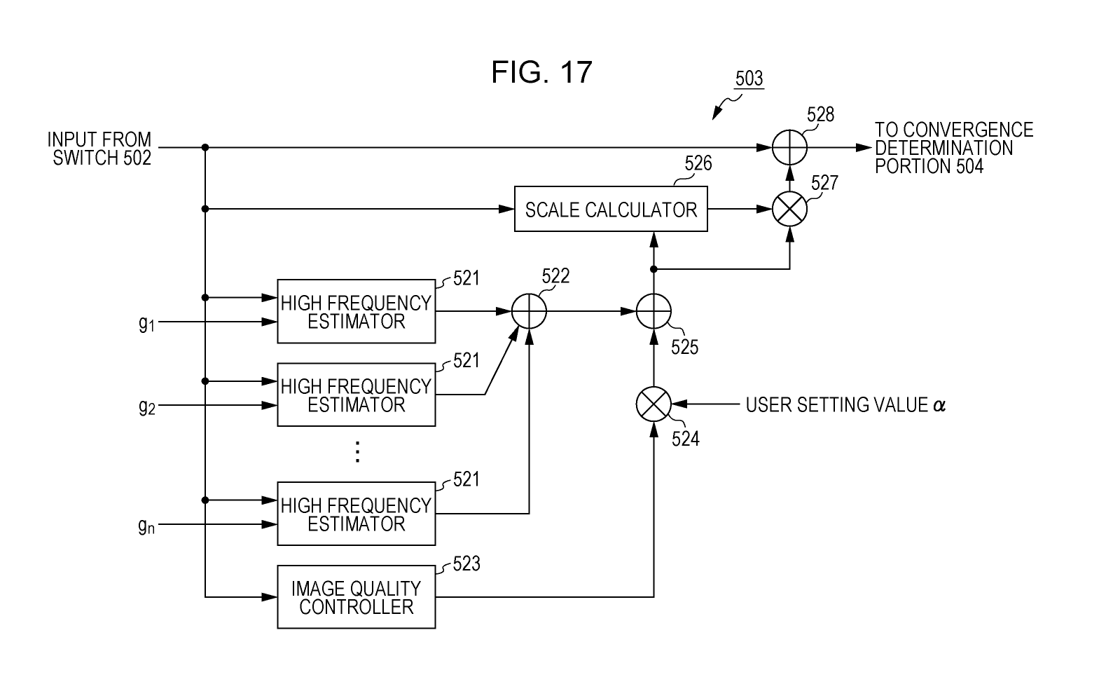

FIG. 17 is a diagram illustrating a detailed configuration of a super resolving processor 503 in the image processing apparatus 500 illustrated in FIG. 16.

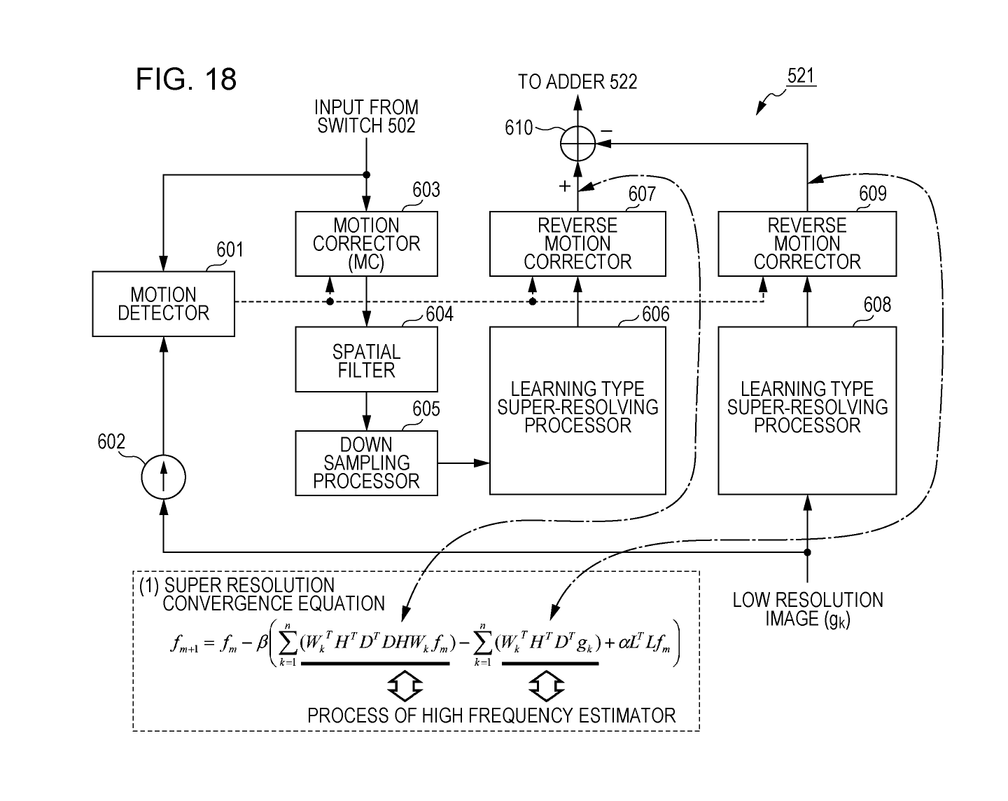

FIG. 18 is a diagram illustrating a detailed configuration of a high frequency estimator 521 in the super resolving processor 503 illustrated in FIG. 17.

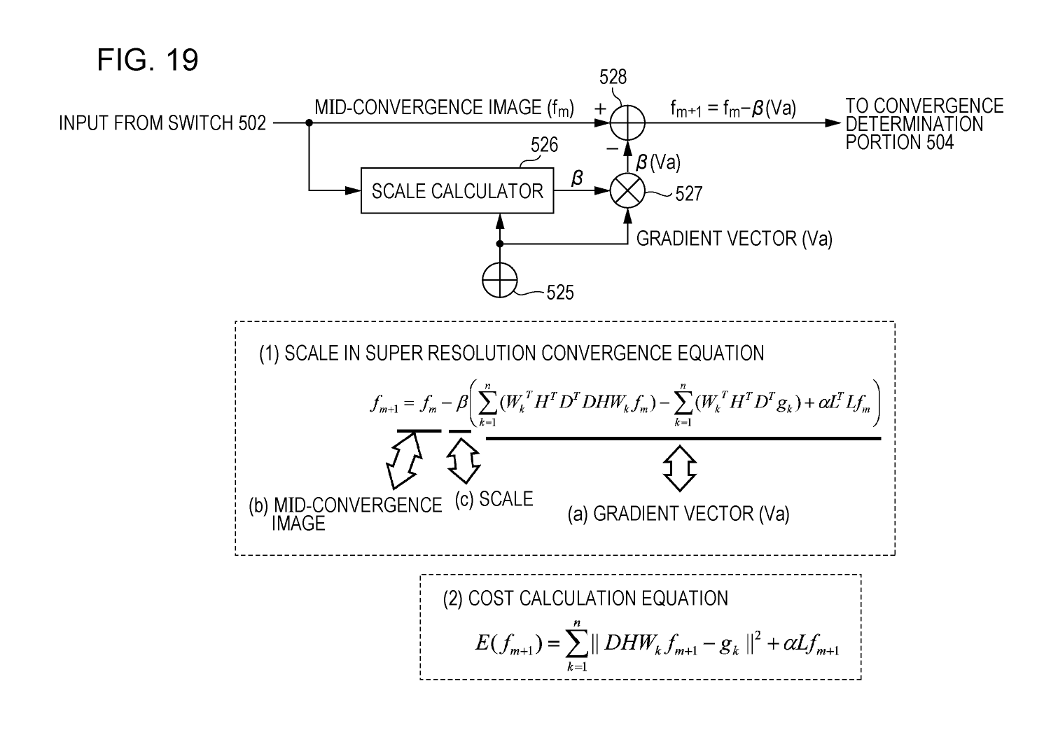

FIG. 19 is a diagram illustrating details of input/output data of a scale calculator 526 and peripheral calculators in the super resolving processor 503 illustrated in FIG. 17.

The image processing apparatus 500 illustrated in FIG. 16 has the same configuration as that of the image processing apparatus 110 performing the reconstruction type super resolving process described above with reference to FIG. 3. The image processing apparatus 500 includes an initial image generation unit 501, a switch 502, a super resolving processor 503, and a convergence determination portion 504.

In the image processing apparatus 500 according to the invention, the configuration of the high frequency estimator 521 constructed in the super resolving processor 503 is different from the aforementioned configuration in the related art, so that a different process is performed.

The image processing apparatus 500 illustrated in FIG. 16 is input with a plurality (n) of the low resolution images g₁ to gn and outputs one high resolution image fₘ. The g₁, g₂, . . . gₙ illustrated in FIG. 16 indicate n low resolution input images.

The initial image generation unit 501 sets an initial value of the super resolving process result. The initial value may be an arbitrary value. For example, the low resolution image g₁ is input, and an image where the g₁ is spread is output.

The switch 502 turns to the output side of the initial image generation unit 501 only at the time of first performance, and in other cases, the switch 502 is operated so that the previous-time output of the convergence determination portion 504 is input to the super resolving processor 503.

The super resolving processor 503 is input with the n low resolution images g₁, g₂, g₃ . . . gₙ and the image from the switch 502 and output the result to the convergence determination portion 504. Details of the super resolving processor 503 are described later.

The convergence determination portion 504 is input with the output of the super resolving processor 503 and determines whether or not sufficient convergence is performed. In the case where sufficient convergence is determined to be performed from the result of the super resolving processor 503, the convergence determination portion 504 outputs the result of the process to an external portion and stops the process. In the case where the process is determined to be insufficient, the above data are input through the switch 502 to the super resolving processor 503, and the calculation is performed again. For example, the convergence determination portion 504 extracts a difference between the newest process result and the previous-time process result, and in the case where the difference is equal to or smaller than a predetermined value, it is determined that the convergence is performed. Alternatively, in the case where the number of processes reaches a predetermined number of processes, it is determined that the convergence is performed, and the process result is output.

Details of a configuration and process of the super resolving processor 503 are described with reference to FIG. 17. In addition, the configuration of the super resolving processor 503 illustrated in FIG. 17 are substantially the same as that of the super resolving processor 113 described above with reference to FIG. 4. However, the configuration of the high frequency estimator 521 is different from the aforementioned configuration in the related art, so that a different process is performed.

As illustrated in FIG. 17, the super resolving processor 503 includes a plurality of the high frequency estimator 521, an image quality controller 523, a scale calculator 526, and calculators such as adders 522, 525, and 528 and multipliers 524 and 527.

The super resolving processor 503 is input with the input from the switch 502 illustrated in FIG. 16, that is, a plurality (n) of the low resolution images g₁, g₂, . . . gₙ and outputs a process result to the convergence determination portion 504. In addition, the super resolving processor 503 is input with a user setting value a as an image adjustment parameter.

Each of the high frequency estimators 521 is input with an image as a mid-reconstruction result image which is the input from the switch 502 and one of the low resolution images a g₁, g₂, . . . gₙ and outputs the process result to the adder 522. Each of the high frequency estimators 521 calculates a correction value for recovering the high frequency of the image. Details of the process of the high frequency estimator 521 are described later.

The adder 522 adds the results of the high frequency estimators 521 and outputs the process result to the adder 525.

The image quality controller 523 calculates a control value of the pixel value to be used for an ideal image based on a pre-establishment model of the image. The output of the image quality controller 523 is input to the multiplier 524.

The multiplier 524 multiplies the output of the image quality controller 523 with the user setting value α. The image quality of the final image is controlled according to the value of the user setting value α. In addition, in the configuration illustrated in the figure, the user setting value is taken so as to perform the control of the image quality. However, a fixed value may be used without occurrence of a problem.

The adder 525 adds the output of the adder 522 and the output of the multiplier 524 and outputs the calculation result to the scale calculator 526 and the multiplier 527. The scale calculator 526 is input with the mid-calculation result from the switch 512 and the pixel value control signal from the adder 525 to determine the scale value for the final control value. The result of the scale calculator 526 is output to the multiplier 527. The multiplier 527 multiplies the control value of the adder 525 with the output value of the scale calculator 526 and outputs the calculation result to the adder 528. The adder 528 subtracts the result of the multiplier 527 from the mid-processing result from the switch 502 and outputs the result to the convergence determination portion 504.

A detailed configuration and process of each of a plurality of the high frequency estimators 521 set in the super resolving processor 503 illustrated in FIG. 17 are described with reference to FIG. 18.

The high frequency estimator 521 performs a process corresponding to the process of calculation in the lower line portion illustrated in FIG. 18 (1) in the aforementioned supper resolution convergence equation (Equation 12).

The motion detector 601 is input with the high resolution image from the switch 502 and the low resolution image gₖ to detect a size of the motion between the two images. More specifically, the motion detector 601 calculates the motion vector.

In addition, as a preparation, since the motion is different between the two images, the resolution converter 602 constructed with, for example, an upsampling filter performs an upsampling process on the low resolution image gₖ, and performs a process of combining a resolution with a to-be-generated high resolution image.

The motion corrector (MC) 603 is input with the high resolution image from the switch 502 and the motion vector from the motion detector 601 and performs a transform on the input high resolution image. The process corresponds to the process of calculation of the motion (Wₖ) in the aforementioned supper resolution convergence equation (Equation 12) illustrated in FIG. 18 (1).

The spatial filter 604 performs a process of simulation of the deterioration in the spatial resolution. Herein, convolution is performed on the image by using a pre-measured point spread function as a filter. The process corresponds to the process of calculation of the blur (H) in the aforementioned supper resolution convergence equation (Equation 12) illustrated in FIG. 18 (1).

The downsampling processor 605 performs a downsampling process on the high resolution image down to the resolution equal to that of the input image. The process corresponds to the process of calculation of the camera resolution (D) in the aforementioned supper resolution convergence equation (Equation 12) illustrated in FIG. 18 (1).

The low resolution image generated through the downsampling of the high resolution image in the downsampling processor 605 is input to the learning type super resolving processor 606.

The learning type super resolving processor 606 has the same configuration as that of the learning type super resolving process performing unit 340 described above with reference to FIG. 15, so that the same process is performed.

The low resolution image generated through the downsampling provided from the downsampling processor 605 corresponds to the low resolution image 371 illustrated in FIG. 15. The learning type super resolving processor 606 performs the learning type super resolving process using the learned data stored in advance in the database to generate the high resolution image. In other words, the learning type super resolving processor 606 generates the high resolution image as data corresponding to the high resolution image 372 illustrated in FIG. 15.

At the same time, the learning type super resolving processor 608 is input with the low resolution image (gₖ) which is input to the high frequency estimator 521. The learning type super resolving processor 608 has the same configuration as that of the learning type super resolving process performing unit 340 described above with reference to FIG. 15, so that the same process is performed to generate the high resolution image.

In addition, the learning type super resolving processor 606 and the learning type super resolving processor 608 perform an upsampling process as a learning type super resolving process using the learned data including data corresponding to feature amount information of a localized image area of the low resolution image and the high resolution image generated based on the low resolution image and image transform information for converting the low resolution image into the high resolution image.

In addition, the learning type super resolving processor 606 and the learning type super resolving processor 608 may have a configuration where only the input data are different and the same processes are simultaneously performed or a configuration where individual processes using learned data or algorithm optimized to each process are performed.

Through these processes, the learning type super resolving processor 606 generates a first high resolution image, and the learning type super resolving processor 608 generates a second high resolution image.

The first high resolution image generated by the learning type super resolving processor 606 is a high resolution image generated by inputting the low resolution image generated through the downsampling process of the high resolution image input from the switch 502 and performing the learning type super resolving process.

The second high resolution image generated by the learning type super resolving processor 608 is a high resolution image generated by inputting the low resolution image (gₖ) input to the high frequency estimator 521 and performing the learning type super resolving process.

The first high resolution image generated by the learning type super resolving processor 606 and the second high resolution image generated by the learning type super resolving processor 608 are input to the reverse motion correctors 607 and 609.

Each of the reverse motion correctors 607 and 609 performs reverse correction of the motion on each of the high resolution images. The reverse motion correction which is offset with the motion correction process of the motion corrector 603 is performed.

The adder 610 subtracts the output of the reverse motion corrector 609 from the output of the reverse motion corrector 607. In other words, the difference data in the reverse motion correction image between the first high resolution image generated by inputting the low resolution image generated through the downsampling process of the high resolution image input from the switch 502 and performing the learning type super resolving process and the second high resolution image generated by inputting the low resolution image (gₖ) input to the high frequency estimator 521 and performing the learning type super resolving process is generated. The difference data are output to the adder 522.

In addition, as illustrated in FIG. 18, the output of the reverse motion corrector 607 and the output of the reverse motion corrector 609 correspond to the following data in the aforementioned supper resolution convergence equation (Equation 12) illustrated in FIG. 18 (1).

The output of the reverse motion corrector 607 corresponds to Wₖ^{T}H^{T}D^{T}DHWₖfₘ in the supper resolution convergence equation (Equation 12), and the output of the reverse motion corrector 609 corresponds to Wₖ^{T}H^{T}D^{T}gₖ in the supper resolution convergence equation (Equation 12).

As illustrated in FIG. 17, the adder 522 is input with outputs of the high frequency estimators 521, which are input with different low resolution images g₁ to gₙ, and adds the outputs of the high frequency estimators 521. The output of the adder 522 is (Σ(Wₖ^{T}H^{T}D^{T}DHWₖfₘ)−Σ(Wₖ^{T}H^{T}D^{T}gₖ)) which is the aforementioned partial data in the supper resolution convergence equation (Equation 12), that is, the data corresponding to a portion of the gradient vector (a) illustrated in FIG. 19 (1).

In this manner, the adder 522 adds the results of the high frequency estimators 521 and outputs the process result to the adder 525.

The image quality controller 523 calculates a control value of the pixel value to be used for an ideal image based on a pre-establishment model of the image. The output of the image quality controller 523 is input to the multiplier 524.

The multiplier 524 multiplies the output of the image quality controller 523 with the user setting value α. The image quality of the final image is controlled according to the value of the user setting value α.

The output of the multiplier 524 corresponds to αL^{T}Lfₘ in the supper resolution convergence equation (Equation 12).

In addition, in the configuration illustrated in the figure, the user setting value is taken so as to perform the control of the image quality. However, a fixed value may be used without occurrence of a problem.

The processes of the adder 525, the scale calculator 526, and the like are described with reference to FIG. 19. The adder 525 adds the output of the adder 522 and the output of the multiplier 524 and outputs the calculation result to the scale calculator 526 and the multiplier 527. The scale calculator 526 is input with the mid-calculation result from the switch 512 and the pixel value control signal from the adder 525 and determines the scale value for the final control value.

The scale calculator 526 determines the scale (coefficient β) for the gradient vector in the image convergence calculation using a steepest descent method. In other words, the scale calculator 526 determines the coefficient β in the aforementioned supper resolution convergence equation (Equation 12) illustrated in FIG. 19 (1). The coefficient β is a multiplication coefficient for the gradient vector (Va) in the aforementioned supper resolution convergence equation (Equation 12) illustrated in FIG. 19 (1).

The scale calculator 526 is input with the gradient vector ((a) gradient vector (Va) in the aforementioned supper resolution convergence equation (Equation 12) illustrated in FIG. 19 (1)) from the adder 525 and receives the mid-converging image ((b) mid-converging image (fₘ) in the aforementioned supper resolution convergence equation (Equation 12) illustrated in FIG. 19 (1)) through the switch 502.

The scale calculator 526 obtains the coefficient β based on these inputs so that the cost E(fₘ₊₁) expressed in the cost calculation equation described as the aforementioned equation (Equation 10) illustrated in FIG. 19 (2) is minimized.

As a process of calculation of the coefficient β, the coefficient β for the minimization is calculated by generally using a method such as binary search. In addition, in the case where the reduction in the cost of the calculation is desired, a configuration where a constant number is output regardless of an input may be used.

The result (β) of the scale calculator 526 is output to the multiplier 527. The multiplier 527 multiplies the gradient vector (Va) obtained as an output of the adder 525 with the output value (β) of the scale calculator 526 and outputs β(Va) to the adder 528. The adder 528 performs a process of subtracting β(Va), which is an input from the multiplier 527, from the super resolving processed image fₘ as the m-th super resolving process result, which is input as a mid-processing result of the super resolving process from the switch 502 and outputs the (m+1)-th super resolving process result fₘ₊₁.

In other words, fₘ₊₁=fₘ−β(Va)

The (m+1)-th super resolving process result fₘ₊₁ is calculated based on the above equation. This equation corresponds to the aforementioned supper resolution convergence equation (Equation 12) illustrated in FIG. 19 (1).

The super resolving processor 503 outputs the (m+1)-th super resolving process result, that is, fₘ₊₁=fₘ−β(Va) to the convergence determination portion 504.

The convergence determination portion 504 is input with the (m+1)-th super resolving process result, that is, fₘ₊₁=fₘ−β(Va) from the super resolving processor 503 and determines based on the input whether or not sufficient convergence is performed.

In the case where sufficient convergence is determined to be performed from the result of the super resolving processor 503, the convergence determination portion 504 outputs the result of the process to an external portion and stops the process. In the case where the process is determined to be insufficient, the above data are input through the switch 502 to the super resolving processor 503, and the calculation is performed again. For example, the convergence determination portion 504 extracts a difference between the newest process result and the previous-time process result, and in the case where the difference is equal to or smaller than a predetermined value, it is determined that the convergence is performed. Alternatively, in the case where the number of processes reaches a predetermined number of processes, it is determined that the convergence is performed, and the process result is output.

### (3b) Second Embodiment

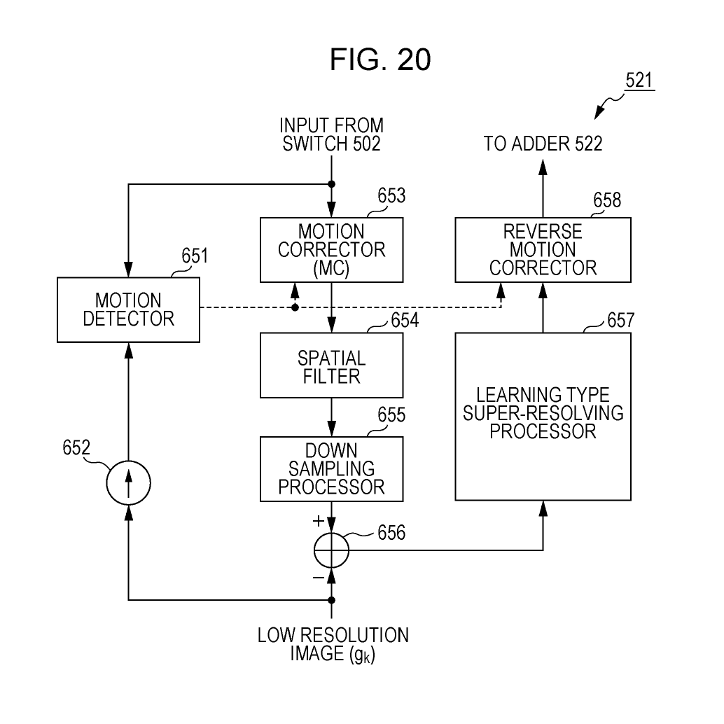

Next, an image processing apparatus according to a second embodiment of the invention is described with reference to FIG. 20.

In the second embodiment, the basic configuration is the same as that of the aforementioned first embodiment except that the configuration of the high frequency estimator 521 in the first embodiment is modified.

The basic configuration of the image processing apparatus according to the second embodiment is the same as that of the first embodiment as illustrated in FIG. 16.

The configuration of the super resolving processor 503 is also the same as that of the first embodiment as illustrated in FIG. 17.

The configuration of the high frequency estimator 521 in the super resolving processor 503 is different from that of the first embodiment (FIG. 18). The configuration in the second embodiment is illustrated in FIG. 20.

The configuration and process of the high frequency estimator 521 according to the second embodiment are described with reference to FIG. 20.

The high frequency estimator 521 performs a process corresponding to the calculation process in the lower line portion illustrated in FIG. 18 (1) in the aforementioned supper resolution convergence equation (Equation 12).

The motion detector 651 is input with the high resolution image from the switch 502 and the low resolution image gₖ in the image processing apparatus 500 illustrated in FIG. 16 to detect a size of the motion between the two images. More specifically, the motion detector 651 calculates the motion vector.

In addition, as a preparation, since the motion is different between the two images, the resolution converter 652 constructed with, for example, an upsampling filter performs an upsampling process on the low resolution image gₖ, and performs a process of combining a resolution with a to-be-generated high resolution image.

The motion corrector (MC) 653 is input with the high resolution image from the switch 502 and the motion vector from the motion detector 601 and performs a transform on the input high resolution image. The process corresponds to the process of calculation of the motion (Wₖ) in the aforementioned supper resolution convergence equation (Equation 12) illustrated in FIG. 18 (1).

The spatial filter 654 performs a process of simulation of the deterioration in the spatial resolution. Herein, convolution is performed on the image by using a pre-measured point spread function as a filter. The process corresponds to the process of calculation of the blur (H) in the aforementioned supper resolution convergence equation (Equation 12) illustrated in FIG. 18 (1).

The downsampling processor 655 performs a downsampling process on the high resolution image down to the resolution equal to that of the input image. The process corresponds to the process of calculation of the camera resolution (D) in the aforementioned supper resolution convergence equation (Equation 12) illustrated in FIG. 18 (1).

The low resolution image generated through the downsampling of the high resolution image in the downsampling processor 655 is input to the subtractor 656.

The subtractor 656 calculates the difference value for each pixel between the low resolution image generated by the downsampling processor 655 and the low resolution image gₖ input to the high frequency estimator 521.

The difference image as a difference value calculated by the subtractor 656 is input to the learning type super resolving processor 657.

The learning type super resolving processor 657 has the same configuration as that of the learning type super resolving process performing unit 340 described above with reference to FIG. 15, so that the same process is performed. However, in this case, a process on the difference image is performed.

The difference image data generated by the subtractor 656, that is, the difference image data which are constructed with difference values of pixels between the low resolution image generated through the downsampling of the high resolution image and the input low resolution images gₖ correspond to the low resolution image 371 illustrated in FIG. 15.

The learning type super resolving processor 657 performs the learning type super resolving process using the learned data stored in advance in the database to generate the high resolution difference image constructed with the difference data. In other words, the learning type super resolving processor 657 generates the high resolution difference image constructed with the difference data as data corresponding to the high resolution image 372 illustrated in FIG. 15.

In addition, the learned data stored in the database, which are used for the learning type super resolving process, are the learned data for generating the difference data corresponding to the high resolution difference image from the difference image data which are constructed with the difference values of pixels in the low resolution images.

In this manner, the learning type super resolving processor 657 performs a learning type super resolving process in the upsampling process on the difference image between the downsampling processed image, which is converted to have the same resolution as that of the low resolution image through a downsampling process of the processed image constructed with the high resolution images, and the low resolution image input as a processing object image of the super resolving process.

In addition, the learning type super resolving processor 657 performs an upsampling process as a learning type super resolving process using the learned data including data corresponding to feature amount information of a localized image area of the difference image between the low resolution image and the high resolution image generated based on the low resolution image and image transform information for converting the difference image into the high resolution difference image.

The high resolution difference image data generated by the learning type super resolving processor 657 are input to the reverse motion corrector 658.

The reverse motion corrector 658 performs reverse correction of the motion on the high resolution image as a difference image. The reverse motion correction which is offset with the motion correction process of the motion corrector 603 is performed. The difference data is output to the adder 522.

The output of the reverse motion corrector 658 is the data corresponding to the output of the adder 610 of the high frequency estimator 521 illustrated in FIG. 18 described above as the first embodiment.

In other words, the second embodiment is different from the first embodiment in that, in the first embodiment, the learning type super resolving process is performed not on the image difference data but on individual images, and the process of calculating the resulting differences is performed, and in the second embodiment, the difference data are generated in advance, and the learning type super resolving process is performed on the difference data.

With respect to the processes after outputting the difference data to the adder 522, the processes of the second embodiment are the same as those of the first embodiment, and thus, the description thereof is omitted.

As described above, in the first and second embodiments, the upsampling process is configured to be performed as a learning type super resolving process using learned data.

In the first embodiment, the upsampling process which is performed as a process of generating the high resolution image from the low resolution image is configured to be performed as a learning type super resolving process using learned data.

In addition, in the second embodiment, the upsampling process for the difference image between the low resolution images is configured to be performed as a learning type super resolving process using learned data.

In other words, as illustrated in FIG. 18 or 20, the super resolving processor 503 of the image processing apparatus 500 according to the first and second embodiments illustrated in FIG. 16 includes the high frequency estimator which generates the difference image information between the low resolution image input as a processing object image of the super resolving process and the mid-processing image of the super resolving process or the processed image, that is, the initial image. In addition, as illustrated in FIG. 19, the super resolving processor 503 includes the scale calculator 526 which performs the updating process of the processed image through the calculation process of the difference image information output from the high frequency estimator and the processed image and the calculator constructed with the adder, the multiplier, and the like.

As described with reference to FIG. 18 or 20, the high frequency estimator performs the learning type data process using the learned data in the difference image information generating process.

For example, the upsampling process is performed as a learning type super resolving process using learned data, so that the subjective result of the super resolving result is improved. In addition, in the case where the number of input low resolution images is small or even in the case where the input image is extremely deteriorated, the high resolution image having low deterioration in the image quality can be generated.

As described above, in the case where only the reconstruction type super resolving method is used, the following processes are performed as an upsampling process.

(a) Component estimation for high frequency component (equal to or higher than the Nyquist frequency) based on aliasing component (aliasing) in the input screen

(b) Elimination of aliasing component (aliasing) in low frequency component (equal to or lower than the Nyquist frequency) and recovery of high frequency component (equal to or higher than the Nyquist frequency)

However, with respect to this method, in the case where there are a small number of the input images, there is a problem in that the estimation of the aliasing component (aliasing) is not appropriately performed. In addition, even in the case where the aliasing component may not be detected in the input image caused by an extreme deterioration of the input image, similarly, the high frequency performance is insufficient.

In the configuration of the invention, at the time of the upsampling process, the learning type super resolving process using the learned data is configured to be performed, and the upsampling process without occurrence of defects in the reconstruction type super resolving process as described above can be performed.

### (3c) Third Embodiment

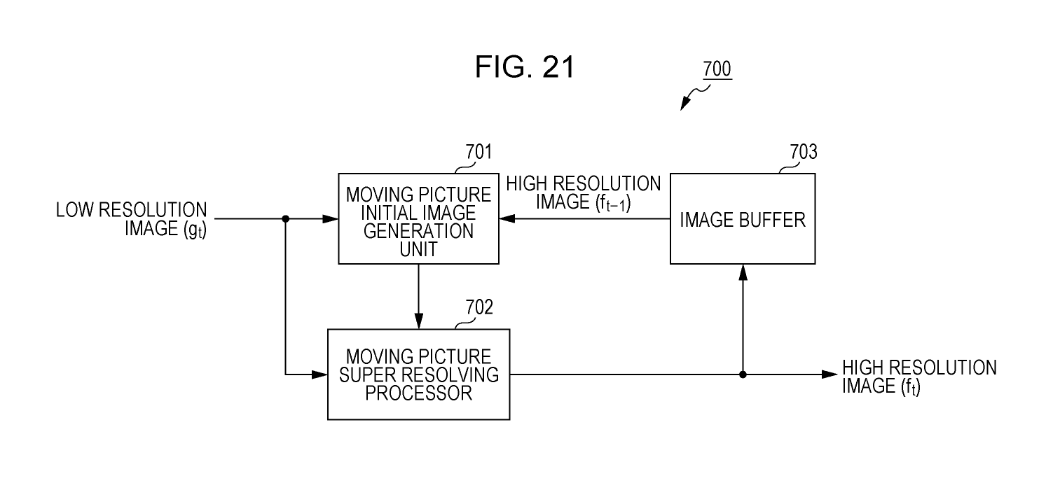

Next, an image processing apparatus according to a third embodiment of the invention is described with reference to FIG. 21 and the following figures. In the third embodiment, the image processing apparatus performs the super resolving process of the case where the processing object is specified to a moving picture.

The basic configuration of the image processing apparatus according to the third embodiment is the same as that of the image processing apparatus 200 performing the reconstruction type super resolving process described above with reference to FIG. 8.

However, the configuration and process of the high frequency estimator in the image processing apparatus according to the third embodiment are different from those of the image processing apparatus 200.

The basic configuration of the image processing apparatus according to the third embodiment is described with reference to FIG. 21.

As illustrated in FIG. 21, the image processing apparatus 700 includes a moving picture initial image generation unit 701, a moving picture super resolving processor 702, and an image buffer 703.

In the process for a moving picture, the following definitions are used.

gₜ: one frame of a low resolution moving picture at a time point t

fₜ: one frame of a high resolution moving picture at a time point t

In this manner, a low resolution image gₜ is set to one frame of the low resolution moving picture at a time point t, and a high resolution image fₜ is the high resolution image obtained as a result of the super resolving process applied on the low resolution image gₜ.

In the image processing apparatus 700 illustrated in FIG. 21, the low resolution image gₜ is input to the moving picture initial image generation unit 701 and the moving picture super resolving processor 702.

The moving picture initial image generation unit 701 is input with the previous-frame moving picture super resolving process results (fₜ₋₁) and (gₜ) and outputs the generated initial image to the moving picture super resolving processor 702. Details of the moving picture initial image generation unit 701 are described later.

The moving picture super resolving processor 702 generates the high resolution image (fₜ) by applying the low resolution image (gₜ) to the input initial image and outputs the high resolution image (fₜ). Details of the moving picture super resolving processor 702 are described later.

The high resolution image output from the moving picture super resolving processor 702 is output to the image buffer 703 at the same time of being output to an external portion, so that the high resolution image is used for the super resolving process for the next frame.

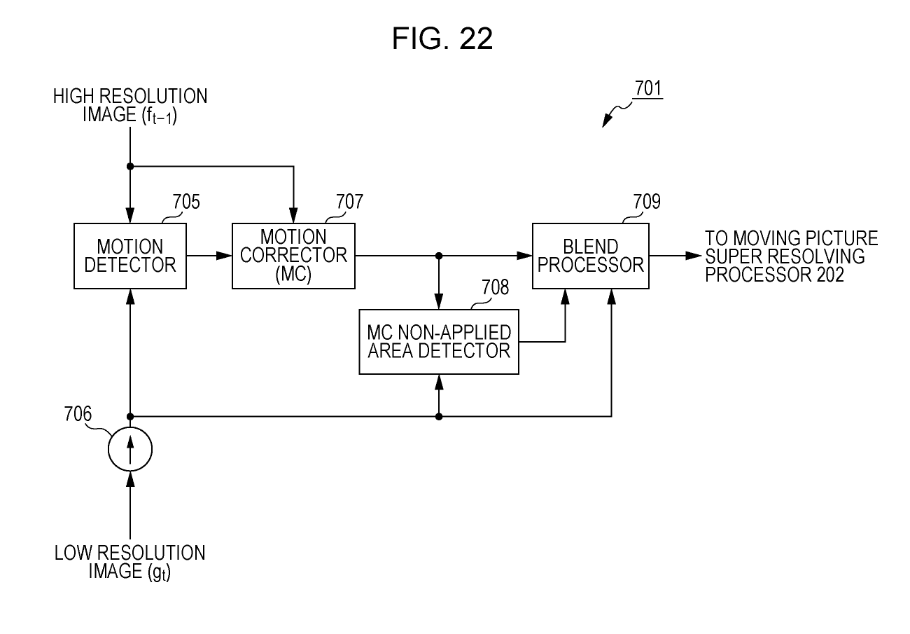

Next, a detailed configuration and process of the moving picture initial image generation unit 701 are described with reference to FIG. 22. The moving picture initial image generation unit 701 is input with the previous-frame moving picture super resolving process results (fₜ₋₁) and (gₜ) and outputs the generated initial image to the moving picture super resolving processor 702.

First, a process of combining the resolution of the low resolution image gₜ and the resolution of the to-be-generated high resolution image is performed by performing the upsampling process by the resolution converter 706 constructed with, for example, an upsampling filter.

The motion detector 705 detects a size of the motion between the previous-frame high resolution image fₜ₋₁ and the upsampled low resolution image gₜ. More specifically, the motion detector 705 calculates the motion vector.

In the motion corrector (MC) 707, the motion corrector (MC) 707 performs a motion correction process on the high resolution image fₜ₋₁ by using the motion vector detected by the motion detector 705. Therefore, the motion correction is performed on the high resolution image fₜ₋₁, so that a motion correction image where a position of the subject is set to be the same as that in the upsampled low resolution image gₜ is generated.

The MC non-applied area detector 708 detects an area where the motion correction (MC) is not well applied by comparing the high resolution image generated by the motion correction (MC) process with the upsampled low resolution image. The MC non-applied area detector 708 sets appropriateness information α [0:1] of MC application in units of a pixel and output the appropriateness information.

The blend processor 709 is input with the motion correction resulting image for the high resolution image fₜ₋₁, which is generated by the motion corrector (MC) 707, the upsampled image which is obtained by upsampling the low resolution image gₜ in the resolution converter 706, and the MC non-applied area detection information which is detected by the MC non-applied area detector 708.

The blend processor 709 outputs the moving picture super resolution initial image as a blend result based on the following equation by using the above input information.

moving picture super resolution initial image(blend result)=(1−α)(upsampled image)+α(motion correction resulting image)

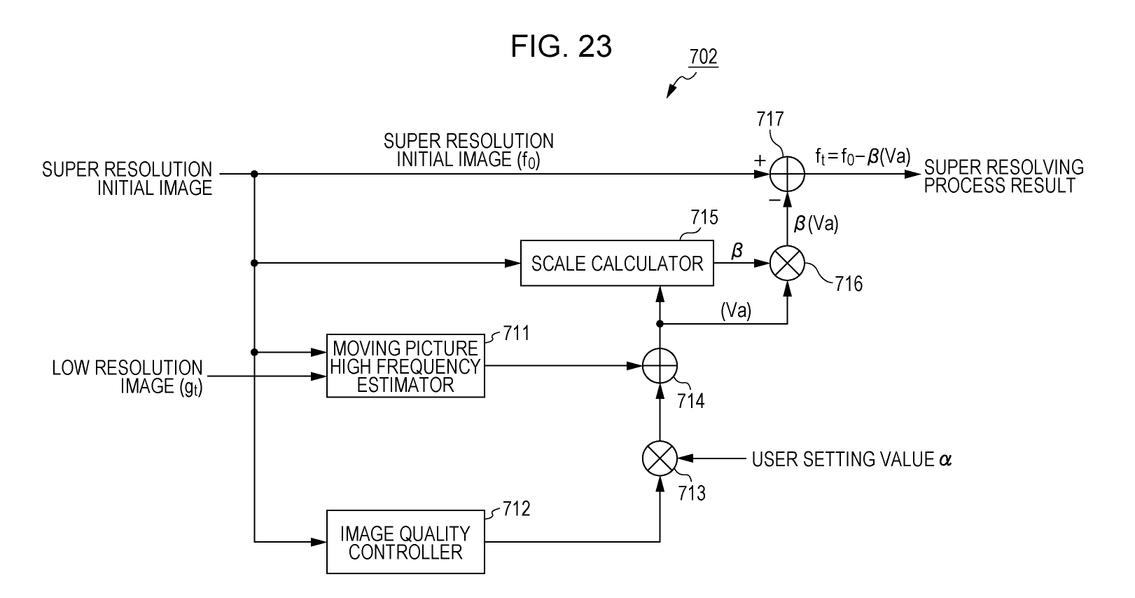

Next, a configuration and process of the moving picture super resolving processor 702 in the image processing apparatus 700 performing the reconstruction type super resolving process illustrated in FIG. 21 are described with reference to FIG. 23. As illustrated in FIG. 23, the moving picture super resolving processor 702 includes a moving picture high frequency estimator 711, an image quality controller 712, a scale calculator 715, and calculators such as adders 714 and 717 and multipliers 713 and 716.

The moving picture super resolving processor 702 is input with the moving picture super resolution initial image as the aforementioned blend result from the moving picture initial image generation unit 701 illustrated in FIG. 21. In other words, the moving picture super resolving processor 702 is input with the result of the blending, that is, “moving picture super resolution initial image (blend result)=(1−α)(upsampled image)+α(motion correction resulting image)”.

Furthermore, the moving picture super resolving processor 702 is input with the low resolution image gₜ and the user setting value α as an image adjustment parameter to generate the high resolution image (fₜ) as a process result and outputs the high resolution image (fₜ).

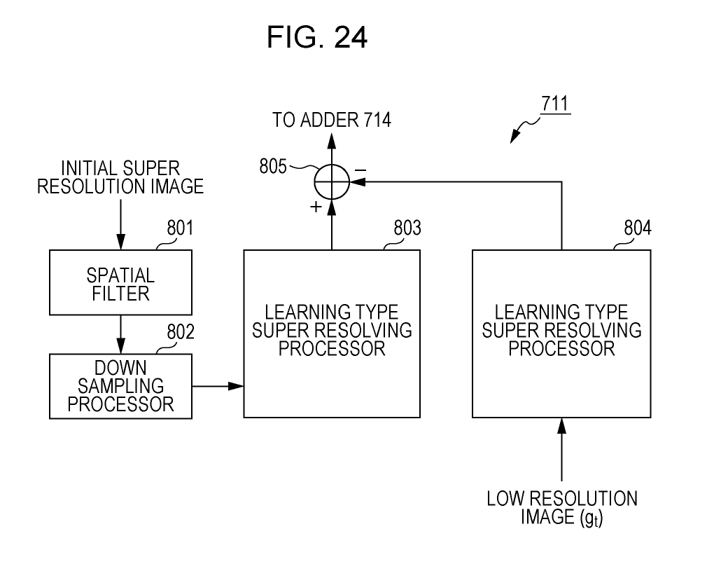

A detailed configuration and process of the moving picture high frequency estimator 711 in the moving picture super resolving processor 702 are described with reference to FIG. 24. The moving picture high frequency estimator 711 calculates a correction value for recovering the high frequency of the image. The moving picture high frequency estimator 711 is input with the moving picture super resolution initial image as the aforementioned blend result generated by the moving picture initial image generation unit 701 and the low resolution image (gₜ) and outputs the process result to the adder 714.

The spatial filter 801 illustrated in FIG. 24 is input with the moving picture super resolution initial image as the aforementioned blend result generated by the moving picture initial image generation unit 701 and performs a process of simulation of the deterioration in the spatial resolution. Herein, convolution is performed on the image by using a pre-measured point spread function as a filter. The process corresponds to the process of calculation of the blur (H) (refer to FIG. 18 (1)) in the aforementioned supper resolution convergence equation (Equation 12).

The downsampling processor 802 performs a downsampling process on the high resolution image down to the resolution equal to that of the input image. The process corresponds to the process (refer to FIG. 18 (1)) of calculation of the camera resolution (D) in the aforementioned supper resolution convergence equation (Equation 12).

After that, the low resolution image generated through the downsampling of the high resolution image in the downsampling processor 802 is input to the learning type super resolving processor 803.

The learning type super resolving processor 803 has the same configuration as that of the learning type super resolving process performing unit 340 described above with reference to FIG. 15, so that the same process is performed.

The low resolution image generated through the downsampling provided from the downsampling processor 802 corresponds to the low resolution image 371 illustrated in FIG. 15. The learning type super resolving processor 803 performs the learning type super resolving process using the learned data stored in advance in the database to generate the high resolution image. In other words, the learning type super resolving processor 803 generates the high resolution image as data corresponding to the high resolution image 372 illustrated in FIG. 15.

At the same time, the learning type super resolving processor 804 is input with the low resolution image (gₜ) which is input to the moving picture high frequency estimator 711. The learning type super resolving processor 804 has the same configuration as that of the learning type super resolving process performing unit 340 described above with reference to FIG. 15, so that the same process is performed to generate the high resolution image.

In addition, the learning type super resolving processor 803 and the learning type super resolving processor 804 perform an upsampling process as a learning type super resolving process using the learned data including data corresponding to feature amount information of a localized image area of the low resolution image and the high resolution image generated based on the low resolution image and image transform information for converting the low resolution image into the high resolution image.

In addition, the learning type super resolving processor 803 and the learning type super resolving processor 804 may have a configuration where only the input data are different and the same processes are simultaneously performed or a configuration where individual processes using learned data or algorithm optimized to each process are performed in advance.

Through these processes, the learning type super resolving processor 803 generates a first high resolution image, and the learning type super resolving processor 804 generates a second high resolution image.

The first high resolution image generated by the learning type super resolving processor 803 is a high resolution image generated by inputting the low resolution image generated through the downsampling process of the initial super resolving image input from the moving picture initial image generation unit 701 and performing the learning type super resolving process.

The second high resolution image generated by the learning type super resolving processor 804 is a high resolution image generated by inputting the low resolution image (gₜ) input to the moving picture high frequency estimator 711 and performing the learning type super resolving process.

The adder 805 generates difference image data by subtracting corresponding pixels of the second high resolution image generated by the learning type super resolving processor 804 from the first high resolution image generated by the learning type super resolving processor 803. The difference data are output to the adder 714.

The image quality controller 712 of the moving picture super resolving processor 702 illustrated in FIG. 23 is constructed with the aforementioned Laplacian transformation portion 141 illustrated in FIG. 6 to perform a process corresponding to the calculation process, which is a partial calculation in the aforementioned supper resolution convergence equation (Equation 12), that is, L^{T}Lfₘ.

The Laplacian transformation portion is input with the moving picture super resolution initial image as the aforementioned blend result generated by the moving picture initial image generation unit 701 and applies the Laplacian operator (L) two times on the moving picture super resolution initial image to output the process result to the multiplier 713 illustrated in FIG. 23.

The scale calculator 715 illustrated in FIG. 23 determines the scale for the gradient vector in the image convergence calculation using a steepest descent method. In other words, the scale calculator 715 determines the coefficient β in the aforementioned supper resolution convergence equation (Equation 12).

The scale calculator 715 is input with the gradient vector ((a) gradient vector in the aforementioned supper resolution convergence equation (Equation 12) illustrated in FIG. 19 (1)) from the adder 714 illustrated in FIG. 23 and further input with the moving picture super resolution initial image as the aforementioned blend result generated by the moving picture initial image generation unit 701.

The scale calculator 715 obtains the coefficient β based on these inputs so that the cost E(fₘ₊₁) expressed in the cost calculation equation described as the aforementioned equation (Equation 10) illustrated in FIG. 19 (2) is minimized.

As a process of calculation of the coefficient β, the coefficient β for the minimization is calculated by generally using a method such as binary search. In addition, in the case where the reduction in the cost of the calculation is desired, a configuration where a constant number is output regardless of an input may be used.

As a result, the coefficient β by which the minimum cost can be set is determined. The coefficient (β) is output to the multiplier 716. The multiplier 716 multiplies the gradient vector (Va) (refer to FIG. 19 (1)) obtained as an output of the adder 714 with the output value (β) of the scale calculator 715 and outputs β(Va) to the adder 717. The adder 717 performs a process of subtracting β(Va), which is an input from the multiplier 716, from the moving picture super resolution initial image f₀ as the aforementioned blend result generated by the moving picture initial image generation unit 701 and outputs the super resolving process result fₜ.

In other words, fₜ=f₀−β(Va)

The super resolving process result fₜ is calculated based on the above equation. This equation corresponds to the aforementioned supper resolution convergence equation (Equation 12) illustrated in FIG. 19 (1).

The moving picture super resolving processor 702 outputs the super resolving process result and stores the super resolving process result to the image buffer 703.

### (3d) Fourth Embodiment

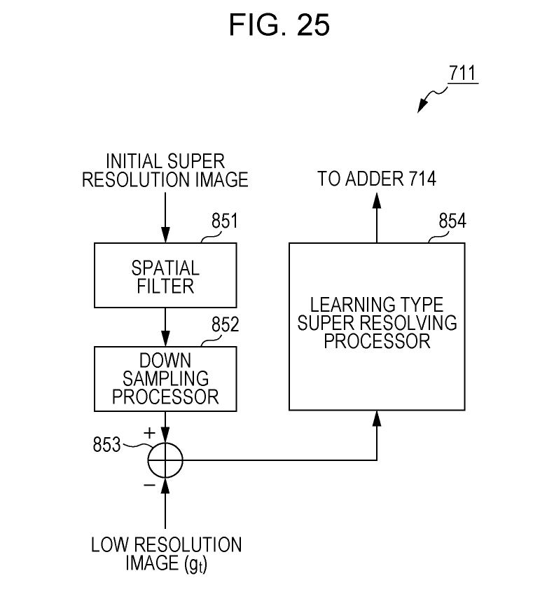

Next, an image processing apparatus according to a fourth embodiment of the invention is described with reference to FIG. 25 and the following figures. Similarly to the third embodiment, in the fourth embodiment, the image processing apparatus performs the super resolving process of the case where the processing object is specified to a moving picture.

The basic configuration of the image processing apparatus according to the fourth embodiment is the same as the aforementioned configuration of the third embodiment illustrated in FIG. 21. In other words, in the image processing apparatus 700 illustrated in FIG. 21, the low resolution image gₜ is input to the moving picture initial image generation unit 701 and the moving picture super resolving processor 702. The moving picture initial image generation unit 701 is input with the previous-frame moving picture super resolving process results (fₜ₋₁) and (gₜ) and outputs the generated initial image to the moving picture super resolving processor 702.

Similarly to the third embodiment, the moving picture initial image generation unit 701 has the configuration illustrated in FIG. 22 to perform the same process as that of the third embodiment. The moving picture super resolving processor 702 generates the high resolution image (fₜ) by applying the low resolution image (gₜ) to the input initial image and outputs the high resolution image (fₜ). Similarly to the third embodiment, the moving picture super resolving processor 702 also has the configuration illustrated in FIG. 23. However, in the configuration illustrated in FIG. 23, the configuration of the moving picture high frequency estimator 711 is different from the configuration of the third embodiment. The high resolution image output from the moving picture super resolving processor 702 is output to the image buffer 703 at the same time of being output to an external portion, so that the high resolution image is used for the super resolving process for the next frame.

The difference between the fourth embodiment and the third embodiment is the configuration of the moving picture high frequency estimator 711 in the moving picture super resolving processor 702 illustrated in FIG. 23.

In the third embodiment, the moving picture high frequency estimator 711 is described to have the configuration illustrated in FIG. 24. However, in the fourth embodiment, the moving picture high frequency estimator 711 is described to have the configuration illustrated in FIG. 25.

The configuration and process of the moving picture high frequency estimator 711 included in the moving picture super resolving processor 702 (refer to FIG. 23) of the image processing apparatus according to the fourth embodiment are described with reference to FIG. 25.

The moving picture high frequency estimator 711 calculates the correction value for recovering the high frequency of the image. The moving picture high frequency estimator 711 is input with the moving picture super resolution initial image as the aforementioned blend result generated by the moving picture initial image generation unit 701 and the low resolution image (gₜ) and outputs the process result to the adder 714.

The spatial filter 851 illustrated in FIG. 25 is input with the moving picture super resolution initial image as the aforementioned blend result generated by the moving picture initial image generation unit 701 illustrated in FIG. 21 and performs a process of simulation of the deterioration in the spatial resolution. Herein, convolution is performed on the image by using a pre-measured point spread function as a filter. The process corresponds to the process (refer to FIG. 18 (1)) of calculation of the blur (H) in the aforementioned supper resolution convergence equation (Equation 12).

The downsampling processor 852 performs a downsampling process on the high resolution image down to the resolution equal to that of the input image. The process corresponds to the process (refer to FIG. 18 (1)) of calculation of the camera resolution (D) in the aforementioned supper resolution convergence equation (Equation 12).

After that, the low resolution image generated through the downsampling of the high resolution image in the downsampling processor 852 is input to the subtractor 853.

The subtractor 853 calculates the difference value for each pixel between the low resolution image generated by the downsampling processor 852 and the low resolution image gₖ input to the moving picture high frequency estimator 711.

The difference image as a difference value calculated by the subtractor 853 is input to the learning type super resolving processor 854.

The learning type super resolving processor 854 has the same configuration as that of the learning type super resolving process performing unit 340 described above with reference to FIG. 15, so that the same process is performed. However, in this case, a process on the difference image is performed.

The difference image data generated by the subtractor 853, that is, the difference image data which are constructed with difference values of pixels between the low resolution image generated through the downsampling of the high resolution image and the input low resolution images gₖ correspond to the low resolution image 371 illustrated in FIG. 15.

The learning type super resolving processor 854 performs the learning type super resolving process using the learned data stored in advance in the database to generate the high resolution difference image corresponding to the difference image. In other words, the learning type super resolving processor 854 generates the high resolution difference image constructed with the difference data as data corresponding to the high resolution image 372 illustrated in FIG. 15.

In addition, the learned data stored in the database, which are used for the learning type super resolving process, are the learned data for generating the difference data corresponding to the high resolution difference image from the difference image data which are constructed with the difference values of pixels in the low resolution images.

In this manner, the learning type super resolving processor 854 performs a learning type super resolving process in the upsampling process on the difference image between the downsampling processed image, which is converted to have the same resolution as that of the low resolution image through a downsampling process of the processed image constructed with the high resolution images, and the low resolution image input as a processing object image of the super resolving process.

In addition, the learning type super resolving processor 854 performs an upsampling process as a learning type super resolving process using the learned data including data corresponding to feature amount information of a localized image area of the difference image between the low resolution image and the high resolution image generated based on the low resolution image and image transform information for converting the difference image into the high resolution difference image.

The high resolution difference image data generated by the learning type super resolving processor 854 are output to the adder 714. The subsequent processes are the same as those of the third embodiment.

In other words, the image quality controller 712 of the moving picture super resolving processor 702 illustrated in FIG. 23 is constructed with the aforementioned Laplacian transformation portion 141 illustrated in FIG. 6 to perform a process corresponding to the calculation process, which is a partial calculation in the aforementioned supper resolution convergence equation (Equation 12), that is, L^{T}Lfₘ.

The Laplacian transformation portion is input with the moving picture super resolution initial image as the aforementioned blend result generated by the moving picture initial image generation unit 701 and applies the Laplacian operator (L) two times on the moving picture super resolution initial image to output the process result to the multiplier 713 illustrated in FIG. 23.

The scale calculator 715 illustrated in FIG. 23 determines the scale for the gradient vector in the image convergence calculation using a steepest descent method. In other words, the scale calculator 715 determines the coefficient β in the aforementioned supper resolution convergence equation (Equation 12).

The scale calculator 715 is input with the gradient vector ((a) gradient vector in the aforementioned supper resolution convergence equation (Equation 12) illustrated in FIG. 19 (1)) from the adder 714 illustrated in FIG. 23 and further input with the moving picture super resolution initial image as the aforementioned blend result generated by the moving picture initial image generation unit 701.

The scale calculator 715 obtains the coefficient β based on these inputs so that the cost E(fₘ₊₁) expressed in the cost calculation equation described as the aforementioned equation (Equation 10) illustrated in FIG. 19 (2) is minimized.

As a process of calculation of the coefficient β, the coefficient β for the minimization is calculated by generally using a method such as binary search. In addition, in the case where the reduction in the cost of the calculation is desired, a configuration where a constant number is output regardless of an input may be used.

As a result, the coefficient β by which the minimum cost can be set is determined. The coefficient (β) is output to the multiplier 716. The multiplier 716 multiplies the gradient vector (Va) (refer to FIG. 19 (1)) obtained as an output of the adder 714 with the output value (β) of the scale calculator 715 and outputs β(Va) to the adder 717. The adder 717 performs a process of subtracting β(Va), which is an input from the multiplier 716, from the moving picture super resolution initial image f₀ as the aforementioned blend result generated by the moving picture initial image generation unit 701 and outputs the super resolving process result fₜ.

In other words, fₜ=f₀−β(Va)

The super resolving process result fₜ is calculated based on the above equation. This equation corresponds to the aforementioned supper resolution convergence equation (Equation 12) illustrated in FIG. 19 (1).

The moving picture super resolving processor 702 outputs the super resolving process result and stores the super resolving process result to the image buffer 703.

The fourth embodiment is different from the third embodiment in that, in the third embodiment, the learning type super resolving process is performed not on the image difference data but on individual images, and the process of calculating the resulting differences is performed, and in the fourth embodiment, the difference data are generated in advance, and the learning type super resolving process is performed on the difference data.

As described above, in the third and fourth embodiments, in the image processing apparatus performing a process in the case where the super resolving processing object is a moving picture, the upsampling process is configured to be performed as a learning type super resolving process using learned data.

In the third embodiment, the upsampling process which is performed as a process of generating the high resolution image from the low resolution image is configured to be performed as a learning type super resolving process using learned data.

In addition, in the fourth embodiment, the upsampling process for the difference image between the low resolution images is configured to be performed as a learning type super resolving process using learned data.

In other words, as illustrated in FIG. 24 or 25, the moving picture super resolving processor 702 of the image processing apparatus 700 according to the third and fourth embodiments illustrated in FIG. 21 includes the moving picture high frequency estimator which generates difference image information between the low resolution image input as a processing object image of the super resolving process and the mid-processing image of the super resolving process or the processed image, that is, the initial image. In addition, as illustrated in FIG. 23, the super resolving processor 702 includes the scale calculator 715 which performs the updating process of the processed image through the calculation process of the difference image information output from the high frequency estimator and the processed image and the calculator constructed with the adder, the multiplier, and the like.

As described with reference to FIG. 24 or 25, the moving picture high frequency estimator performs the learning type data process using the learned data in the difference image information generating process.

For example, the upsampling process is performed as a learning type super resolving process using learned data, so that the subjective result of the super resolving result is improved. In addition, in the case where the number of input low resolution images is small or even in the case where the input image is extremely deteriorated, the high resolution image having low deterioration in the image quality can be generated.

As described above, in the case where only the reconstruction type super resolving method is used, the following processes are performed as an upsampling process.

(a) Component estimation for high frequency component (equal to or higher than the Nyquist frequency) based on aliasing component (aliasing) in the input screen

(b) Elimination of aliasing component (aliasing) in low frequency component (equal to or lower than the Nyquist frequency) and recovery of high frequency component (equal to or higher than the Nyquist frequency)

However, with respect to this method, in the case where there are a small number of the input images, there is a problem in that the estimation of the aliasing component (aliasing) is not appropriately performed. In addition, even in the case where the aliasing component may not be detected in the input image caused by an extreme deterioration of the input image, similarly, the high frequency performance is insufficient.

In the configuration of the invention, at the time of the upsampling process, the learning type super resolving process using the learned data is configured to be performed, and the upsampling process without occurrence of defects in the reconstruction type super resolving process as described above can be performed.

In addition, in the aforementioned first to fourth embodiments, although examples of processes where the upsampling process is performed as a process using the learned data is described, with respect to the downsampling process performed in the image processing apparatus, the learned data may be prepared in advance, and the downsampling process using the learned data may be configured to be performed.

### 4. Example of Hardware Configuration of Image Processing Apparatus

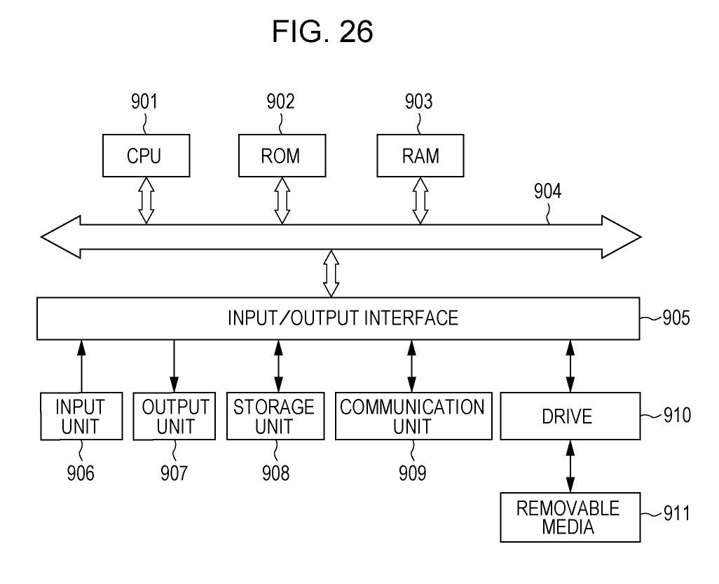

Finally, an example of a hardware configuration of the image processing apparatus performing the aforementioned processes is described with reference to FIG. 26. A CPU (Central Processing Unit) 901 performs various processes according to a program stored in a ROM (Read Only Memory) 902 or a storage unit 908. For example, an image process such as a super resolving process described in the aforementioned embodiments is performed. The program performed by the CPU 901, data, or the like is appropriately stored in a RAM (Random Access Memory) 903. CPU 901, the ROM 902, and the RAM 903 are connected to each other via a bus 904.

The CPU 901 is connected to an input/output interface 905 via the bus 904. An input unit 906 constructed with a keyboard, a mouse, a microphone and an output unit 907 constructed with a display, a speaker, or the like are connected to the input/output interface 905. The CPU 901 performs various processes according to commands input from the input unit 906 and outputs the process result to, for example, the output unit 907.

The storage unit 908 connected to the input/output interface 905 is constructed with, for example, a hard disk to store the program performed by the CPU 901 or various data. A communication unit 909 communicates with external apparatuses through a network such as the Internet or a local area network.

A drive 910 connected to the input/output interface 905 drives a magnetic disk, an optical disk, a magneto-optical disk, a removable media 911 such as a semiconductor memory, or the like to acquire the recorded programs, data, or the like. The acquired programs or data are transmitted and stored in the storage unit 908 if necessary.

Hereinbefore, the invention is described in detail with reference to specific embodiments. However, it is obvious that modifications and alterations of the embodiments can be made by the ordinarily skilled in the related art without departing from the spirit of the invention. In other words, the invention is disclosed through exemplary embodiments, and thus, the embodiments should not be analyzed in a limited meaning. In the determination of the spirit of the invention, the claims should be considered.

In addition, a series of the processes described in the specification can be implemented in a hardware configuration, a software configuration, or a combination thereof. In the case of performing the process in the software configuration, a program recording the process sequence may be installed in a memory in a computer assembled with dedicated hardware to be performed, or the program may be installed in a general-purpose computer which various types of processes can be performed. For example, the program may be recorded in a recording medium in advance. In addition to the installation of the program from the recording medium to the computer, a program may be received via a network such as a LAN (Local Area Network) or the Internet and installed in a recording medium such as an embedded hard disk.

In addition, various types of the processes described in the specification may be performed in a time sequence according to the description and simultaneously or individually according to a processing capability of an apparatus performing the processes or if necessary. In addition, a term “system” in the specification denotes a logical set configuration of a plurality of apparatuses, but it is not limited to a system where the apparatus of each configuration is contained in the same casing.

The present application contains subject matter related to that disclosed in Japanese Priority Patent Application JP 2010-043699 filed in the Japan Patent Office on Mar. 1, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising a super resolving processor including:
a high frequency estimator which generates difference image information between a low resolution image input as a processing object image of a super resolving process and a mid-processing image of the super resolving process or a processed image, that is, an initial image; and
a calculator which performs a process of updating the processed image through a process of calculation between the difference image information output from the high frequency estimator and the processed image,
wherein the high frequency estimator performs a learning type data process using learned data in the difference image information generating process.

2. The image processing apparatus according to claim 1, wherein the high frequency estimator performs the learning type super resolving process in an upsampling process of a downsampling processed image which is converted to have the same resolution as that of the low resolution image through a downsampling process of the processed image constructed with the high resolution images.

3. The image processing apparatus according to claim 1 or 2, wherein the high frequency estimator performs the learning type super resolving process in an upsampling process of the low resolution image input as a processing object image of the super resolving process.

4. The image processing apparatus according to claim 3, wherein the high frequency estimator performs the upsampling process as a learning type super resolving process using the learned data including data corresponding to feature amount information of a localized image area of the low resolution image and the high resolution image generated based on the low resolution image and image transform information for converting the low resolution image into the high resolution image.

5. The image processing apparatus according to claim 1, wherein the high frequency estimator performs the learning type super resolving process in an upsampling process on the difference image between a downsampling processed image, which is converted to have the same resolution as that of the low resolution image through a downsampling process of the processed image constructed with the high resolution images, and the low resolution image input as a processing object image of the super resolving process.

6. The image processing apparatus according to claim 5, wherein the high frequency estimator performs the upsampling process as a learning type super resolving process using the learned data including data corresponding to feature amount information of a localized image area of the difference image between the low resolution image and the high resolution image generated based on the low resolution image and image transform information for converting the difference image into the high resolution difference image.

7. The image processing apparatus according to claim 1, wherein the super resolving processor has a configuration of performing a resolution converting process by using a reconstruction type super resolving method and performs the learning type super resolving process using the learned data in the upsampling process of the resolution converting process.

8. The image processing apparatus according to claim 1, wherein the super resolving processor has a configuration of performing the resolution converting process by taking into consideration a blur and a motion of an image and a resolution of an imaging device according to the reconstruction type super resolving method and performs the learning type super resolving process using the learned data in the upsampling process of the resolution converting process.

9. The image processing apparatus according claim 1, further comprising a convergence determination portion which performs convergence determination on a calculation result of the calculator,
wherein the convergence determination portion performs the convergence determination process according to a predefined convergence determination algorithm and outputs a result corresponding to the convergence determination.

10. An image processing method performed in an image processing apparatus, comprising the steps of:
allowing a high frequency estimator to generate difference image information between a low resolution image input as a processing object image of a super resolving process and a mid-processing image of the super resolving process or a processed image, that is, an initial image; and
allowing a calculator to perform a process of updating the processed image through a process of calculation between the difference image information output from the step of allowing the high frequency estimator to generate the difference image information and the processed image,
wherein in the step of allowing the high frequency estimator to generate the difference image information, a learning type data process using learned data is performed in the difference image information generating process.

11. A program allowing an image processing apparatus to perform an image process, comprising steps of:
allowing a high frequency estimator to generate difference image information between a low resolution image input as a processing object image of a super resolving process and a mid-processing image of the super resolving process or a processed image, that is, an initial image; and
allowing a calculator to perform a process of updating the processed image through a process of calculation between the difference image information output from the step of allowing the high frequency estimator to generate the difference image information and the processed image,
wherein in the step of allowing the high frequency estimator to generate the difference image information, a learning type data process using learned data is performed in the difference image information generating process.
